(19) United States
(12) Patent Application Publication
(10) Pub. No.: US 2026/0042709 A1
(43) Pub. Date: Feb. 12, 2026

(54) SILICON NITRIDE-TYPE SINTERED BODY, BEARING ROLLING ELEMENT, SILICON NITRIDE-TYPE BLANK BALL, AND BEARING

(71) Applicants: AGC Inc., Tokyo (JP); COMBUSTION SYNTHESIS CO., LTD., Sapporo-Shi (JP)

(72) Inventors: Yusaku MATSUO, Chiyoda-ku (JP); Satoshi MIYASAKA, Chiyoda-ku (JP); Tomoki FURUKAWA, Chiyoda-ku (JP); Yuta YOKOYAMA, Chiyoda-ku (JP); Kentaro TAKANAMI, Chiyoda-ku (JP); Shuhei OGAWA, Chiyoda-ku (JP); Kyoko TAYAMA, Chiyoda-ku (JP); Hajime ITO, Chiyoda-ku (JP); Yoshiharu KAGAMI, Sapporo-Shi (JP); Kazuto HARADA, Sapporo-Shi (JP)

(73) Assignees: AGC Inc., Tokyo (JP); COMBUSTION SYNTHESIS CO., LTD., Sapporo-Shi (JP)

(21) Appl. No.: 19/286,403

(22) Filed: Jul. 31, 2025

Related U.S. Application Data
(63) Continuation of application No. PCT/JP2024/003333, filed on Feb. 1, 2024.

(30) Foreign Application Priority Data
Feb. 1, 2023 (JP) 2023-014185

(51) Int. Cl. C04B 35/593; F16C 33/32

(52) U.S. Cl. CPC C04B 35/593; F16C 33/32; C04B 2235/3208; C04B 2235/3217; C04B 2235/3222; C04B 2235/3225; C04B 2235/3418; C04B 2235/3865; C04B 2235/3878; C04B 2235/3882; C04B 2235/3895; C04B 2235/77; C04B 2235/85; C04B 2235/9607; F16C 2206/60

(57) ABSTRACT

A silicon nitride-type sintered body has a total content of at least one metal M selected from the group consisting of Mg. Ca and Y of from 0.2 to 8.0% by mass, an Al content of from 4.0 to 12.0% by mass, an O content of from 4.0 to 12.0% by mass, and a fracture toughness value of from 5.0 to 10.0 MPa·m^{1/2}.

### CROSS-REFERENCE TO RELATED APPLICATIONS

This application is a Continuation of International Application No. PCT/JP2024/003333, filed Feb. 1, 2024, which claims priority to Japanese Patent Application No. 2023-014185 filed Feb. 1, 2023. Each of the above applications is hereby expressly incorporated by reference, in its entirety, into the present application.

### TECHNICAL FIELD

The present invention relates to a silicon nitride-type sintered body, a bearing rolling element, a silicon nitride-type blank ball, and bearing.

### BACKGROUND ART

A silicon nitride sintered body has excellent mechanical strength and wear resistance, and is used for wear-resistant parts, gas turbine blades, engine parts, and the like. Among them, in a silicon nitride sintered body used for bearing members which require high wear resistance, for example, Y₂O₃, Al₂O₃, and the like are added as sintering aids to silicon nitride as a raw material, and the mixture is sintered to generate a grain boundary phase, thereby achieving densification and increased strength of the sintered body. In order to obtain such a dense sintered body, a sintering aid containing rare earth elements such as Y₂O₃ is used.

Furthermore, in some cases, AlN is added as a sintering aid to form a solid solution of silicon nitride known as SiAlON to improve wear resistance. However, because AlN has low water resistance, this method requires preparing a slurry using an organic solvent instead of water and granulating it, which increases costs and produces a small amount of SiAlON.

Accordingly, it has been proposed to use β-SiAlON synthesized by a combustion synthesis method as a raw material and to sinter the same. For example, Patent Document 1 discloses a silicon nitride-based sintered body in which aluminum oxide and yttrium oxide are added as sintering aids to β-SiAlON powder synthesized by a combustion synthesis method, and the mixture is subjected to a single-step sintering process, in which the maximum pore size, contact area ratio, and average crystal grain size are within specified ranges. It is described in Patent Document 1 that the obtained silicon nitride-based sintered body has fine crystal grains with almost no defects that serve as fracture origins and is produced by a single-step heat treatment.

### RELATED ART DOCUMENT

### Patent Document

Patent document 1: Japanese Patent Application Laid-Open (JP-A) No. 2009-12985

### SUMMARY OF INVENTION

### Technical Problem

However, the silicon nitride-type sintered body described in Patent Document 1 has low fracture toughness. This is thought to be because when β-SiAlON powder is used, there is little interlocking structure between the matrix phases during the transformation from the α-phase to the β-phase in liquid-phase sintering.

The silicon nitride-type sintered body has been increasingly applied in various fields including electric vehicles, and in particular, for rolling elements used in bearings, reduction of the machining allowance from a blank ball to a precision ball is required. Accordingly, one embodiment of the present disclosure is directed to providing a silicon nitride-type sintered body having few defects, a bearing rolling element, and a bearing using the same. Another embodiment of the present disclosure is directed to providing a silicon nitride-type sintered body having excellent machinability, a silicon nitride-type blank ball, a bearing rolling element, and a bearing using the same.

### Solution to Problem

The specific means for achieving the above problem are as follows:
<1> A silicon nitride-type sintered body having a total content of at least one metal M selected from the group consisting of Mg, Ca and Y of from 0.2 to 8.0% by mass, an Al content of from 4.0 to 12.0% by mass, an O content of from 4.0 to 12.0% by mass, and a fracture toughness value of from 5.0 to 10.0 MPa·m^{1/2}.
<2> The silicon nitride-type sintered body according to <1>, including a matrix phase and a grain boundary phase, and a total content of the metal M in the grain boundary phase being from 2.0 to 40.0% by mass.
<3> The silicon nitride-type sintered body according to <2>, in which a total content of the metal M in the matrix phase is from 2.0 to 10% by mass.
<4> The silicon nitride-type sintered body according to any one of <1> to <3>, in which the metal M is Ca.
<5> The silicon nitride-type sintered body according to any one of <1> to <4>, including SiAlON in solid solution form.
<6> The silicon nitride sintered-type body according to any one of <1> to <5>, in which a ratio of a maximum peak intensity at from 170 to 190 cm⁻¹ to a minimum peak intensity at from 177 to 197 cm⁻¹ in a Raman spectrum is from 1.0 to 3.0.
<7> The silicon nitride-type sintered body according to any one of <1> to <6>, in which a peak at 185 to 210 cm⁻¹, which is attributed to a β phase, is present between from 187 to 199 cm⁻¹ in a Raman spectrum.
<8> The silicon nitride-type sintered body according to any one of <1> to <7>, having a thermal conductivity of from 5 to 15 W/(m·K).
<9> The silicon nitride-type sintered body according to any one of <1> to <8>, having a density of from 3.10 to 3.20 g/cm³.
<10> The silicon nitride-type sintered body according to any one of <1> to <9>, in which a proportion of a β phase is from 5 to 100%, and the proportion of β phase is expressed as (β(101)+β(120))/(α(210)+α(201)+β(101)+β(120))×100, and calculated from heights of peaks corresponding to an α phase (210), an α phase (201), an β phase (101), and an β phase (120) in an X-ray diffraction spectrum.
<11> The silicon nitride-type sintered body according to any one of <1> to <10>, in which no pores with a major axis of 10 μm or more are observed when a region, having a unit area of 5 mm×5 mm, of a cross section of the silicon nitride-type sintered body is observed under a bright field magnified from 10 to 200 times with an optical microscope.
<12> The silicon nitride-type sintered body according to any one of <1> to <11>, in which no snowflakes with a major axis of 25 μm or more are observed when a region of a unit area of 5 mm×5 mm of a cross section of the silicon nitride-type sintered body is observed under a dark field magnified from 10 to 200 times with an optical microscope.
<13> The silicon nitride-type sintered body according to any one of <1> to <12>, in which no snowflakes with a major axis of 50 μm or more are observed when a region of a cross section of the silicon nitride-type sintered body within 250 μm inward from a surface of the sintered body is observed under a dark field magnified from 10 to 200 times with an optical microscope.
<14> The silicon nitride-type sintered body according to any one of <1> to <13>, which is used for a wear-resistant member.
<15> A silicon nitride-type blank ball including the silicon nitride-type sintered body according to any one of <1> to <14>, in which a difference between a maximum diameter and a minimum diameter is 100 μm or less, and a height of a band-shaped protrusion is 50 μm or less.
<16> A bearing rolling element, including the mirror-finished silicon nitride-type sintered body according to any one of <1> to <14>.
<17> A bearing including the bearing rolling element according to <16>.
<18> The bearing according to <17>, which is for use in an electric vehicle.

### Advantageous Effects of Invention

According to one embodiment of the present disclosure, there is provided a silicon nitride-type sintered body having few defects, a silicon nitride-type blank ball, a bearing rolling element, and a bearing using the same. According to another embodiment in the present disclosure, there are provided a silicon nitride-type sintered body having excellent machinability, a silicon nitride-type blank ball, a bearing rolling element, and a bearing using the same.

### BRIEF DESCRIPTION OF DRAWINGS

FIG. 1 is a schematic diagram of a molded product having a protrusion when a raw material composition is molded into a sphere using a die.

FIG. 2(A) is a cross-section of the spherical silicon nitride-type sintered body of Example 2. This is an image (dark field) of the cross-section near the surface of the sphere after mirror finishing, observed using an optical microscope at 10 times magnification.

FIG. 2(B) is a cross-section of the spherical silicon nitride-type sintered body of Example 6. This is an image (dark field) of the cross-section near the surface of the sphere after mirror finishing, observed using an optical microscope at 10 times magnification.

FIG. 3(A) is a cross-section of the silicon nitride-type sintered body of Example 2. This is an image observed using a scanning electron microscope at 25,000 times magnification after mirror finishing.

FIG. 3(B) is a cross-section of the silicon nitride-type sintered body of Example 6. This is an image observed using a scanning electron microscope at 25,000 times magnification after mirror finishing.

FIG. 4 is a XRD measurement spectrum of the silicon nitride-type sintered body of Example 2.

FIG. 5 is a Raman spectrum of the silicon nitride-type sintered body of Example 2 and Example 6.

FIG. 6 is a Raman spectrum of the silicon nitride-type sintered bodies of Examples 6, 11, 15, 18, and 26.

FIG. 7 is a diagram explaining the Calotest.

FIG. 8 is a schematic diagram of the thrust rolling test equipment.

FIG. 9 is an images of the surfaces of the silicon nitride-type sintered bodies of

Examples 15 and 28 after the thrust rolling test, observed with a laser microscope.

### DESCRIPTION OF EMBODIMENTS

Hereinafter, embodiments in the present disclosure will be described in detail. However, the present disclosure is not limited to the following embodiments.

In the present disclosure, numerical ranges indicated by “to” mean ranges that include the respective numerical values described before and after the “to” as the minimum and maximum values. Unless otherwise specified, the term “to” as used herein shall have the same meaning throughout the present disclosure.

In numerical ranges described in a stepwise manner in the present disclosure, the upper limit value or lower limit value of one range may be replaced with the upper limit value or lower limit value of another stepwise-described range. Additionally, in the numerical ranges described in the present disclosure, the upper limit value or lower limit value of one range may be replaced with a value shown in the examples.

In a case in which the embodiments in the present disclosure are described with reference to the figures, the configuration of the embodiment is not limited to the configuration shown in the figures. In addition, the sizes of the members in each figure are conceptual, and the relative relationships between the sizes of the members are not limited thereto.

In the present disclosure, Vickers hardness is measured in accordance with JIS R1610:2003 using a Vickers hardness tester.

In the present disclosure, fracture toughness is measured by the indentation method (IF method) defined in JIS R 1607:1995, and calculated using the formula proposed by Niihara et al.

In the present disclosure, Young's modulus is measured by the static deflection method in accordance with JIS R1602:1995.

In the present disclosure, density is measured by the Archimedes method.

In the present disclosure, the crushing strength is measured using a Tensilon testing machine in accordance with JIS B1501:2009. The crushing strength value is the average value when 10 samples are measured. The Weibull modulus of crushing strength is the value when 10 samples are measured.

In the present disclosure, the thermal expansion coefficient is measured using a thermomechanical analysis (TMA) measuring machine in accordance with JIS R1618:2002.

In the present disclosure, the three-point bending strength is measured using test pieces measuring 3 mm×4 mm×40 mm under conditions of a span (i.e., distance between supports) of 30 mm and a load application speed of 0.5 mm/min. The three-point bending strength value is the average value when 10 test pieces are measured. The Weibull modulus of three-point bending strength is the value when 10 test pieces are measured.

In the present disclosure, measurements by the X-ray diffraction (XRD) method are performed using an X-ray diffraction device (for example, “Smart lab” manufactured by Rigaku Corporation, detector “D/teXUltra”, and X-ray analysis software “PDXL2”) under the following conditions:
Output: 45 kV-200 mA, scanning range: from 10° to 60°, optical system: focusing method, incident solar slit: 5°, longitudinal limiting slit: 10 mm, receiving slit 1:8 mm, receiving slit 2:13 mm, receiving parallel slit: 5.0°, attenuator open, scanning speed: 5°/min, step width: 0.005°

In the present disclosure, elemental analysis of a silicon nitride-type sintered body is performed using an electron probe microanalyzer (EPMA) device (for example, “JXA-8500F” manufactured by JEOL Ltd. and standard sample) under the following conditions: The measurement sample is subjected to analysis after coating the surface with carbon (30 nm, 10 flashes).

Accelerating voltage: 15 keV, probe current: 30 nA, beam diameter: 30 μm,

In the present disclosure, the content of Mg, Ca, and Y in the grain boundary phase of the silicon nitride-type sintered body is determined by energy dispersive X-ray spectroscopy (EDS) using an EDS analyzer (e.g., Noran system 6 manufactured by Thermo Fisher Scientific, detector: Ultradry manufactured by Thermo Fisher Scientific) under the following conditions.

Line analysis width: 1, number of points: 100, point acquisition interval 50 nm, and the acquired net count is converted to a moving average over three points including one preceding point and one succeeding point. The converted data is normalized so that the maximum value is 1 and the minimum value is 0, the point at which Si and O intersect is defined as the phase boundary, and five points located 150 nm inward from the boundary on the grain boundary phase side are measured, and the average of the obtained values is determined.

In the present disclosure, the contents of Mg, Ca, and Y in the matrix phase of the silicon nitride-type sintered body are determined by the same method as that used to determine the contents of Mg, Ca, and Y in the grain boundary phase, except that the average value is obtained from measurements at points located 150 nm inward from the boundary on the matrix phase side.

In the present disclosure, the amounts of nitrogen and oxygen in the silicon nitride-type sintered body are measured using an oxygen analyzer based on the inert gas fusion-infrared absorption method.

In the present disclosure, the major axis of the pores is calculated by observing and measuring in the bright field (BF) of an optical microscope. Specifically, the cross section of the silicon nitride-type sintered body is mirror-finished, and a region of 5 mm×5 mm unit area at least 2 mm inside from the surface of the mirror-finished cross section is magnified at from 10 to 20 times in a bright field (BF) to confirm the location of the defective portion, and the defective portion is magnified at from 100 to 200 times to measure the major axis of the pore. The longest diameter of a pore is measured as the major axis. Pores and air holes are synonymous, and are confirmed as defects with depth.

The above operations of magnification, observation, and measurement are repeated to confirm whether there is any pore having a major axis of 10 μm or more in a unit area of 5 mm×5 mm. In the case of samples having size smaller than 5 mm×5 mm, a plurality of samples are observed so that the total area becomes 5 mm×5 mm.

In the present disclosure, the major axis of a snowflake is obtained by observing and measuring in the dark field (DF) of an optical microscope. Specifically, the cross section of the sintered body is mirror-finished, and an arbitrary unit area of 5×5 mm on the mirror-finished cross section is magnified at from 10 to 20 times in a dark field (DF) to confirm the location of the defective portion, and the defective portion is magnified at from 100 to 200 times to measure the major axis of the snowflake. The longest diameter of one snowflake is measured as the major axis.

The above operations of magnification, observation, and measurement are repeated to confirm whether there is any snowflake having a major axis of 50 μm or more or 25 μm or more in a unit area of 5 mm×5 mm. In the case of samples having size smaller than 5 mm×5 mm, a plurality of samples are observed so that the total unit area becomes 5 mm×5 mm.

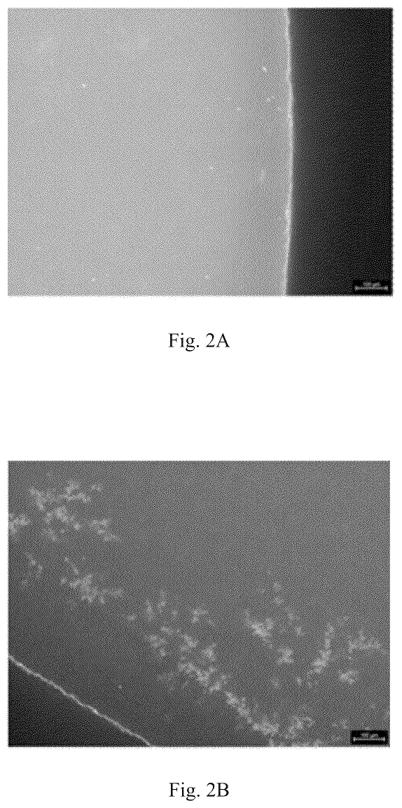

Note that a “snowflake” is a white spot-like defect, and can be confirmed in a dark field (DF) image of an optical microscope, for example, as shown in FIGS. 2 (A) and (B). In the silicon nitride-type sintered body shown in FIG. 2 (B), the snowflakes appear as amorphous white spots near the periphery. The Snowflake is observed at any location on a mirror-finished cross section of a silicon nitride-type sintered body sample, and in a surface layer region within 250 μm inward from the outer surface corresponding to the outer periphery of the sintered body.

In the present disclosure, Raman spectroscopy is performed using a Raman spectroscopy device (e.g., LabRAM HR Evolution manufactured by Horiba, Ltd.) under the following conditions.

Measurement conditions: exposure time 1 second, cumulative 10 times, neutral density filter 100% (power 30 mW), confocal hole 15 μm, laser wavelength: 532 nm, diffraction grating groove number 1200, objective lens 100 times magnification (NA=0.6)

The grinding rate is measured by pressing a #200 diamond metal grinding wheel at a constant pressure of 1.55 kg/cm² into a sample machined to 15 mm square and 5 mm thickness.

The arithmetic mean surface roughness Ra is measured in accordance with JIS B0601:2013 using a surface roughness measuring device (e.g., a Surfcom measuring device) at a scanning speed of 1 mm/s and a scanning distance of 3 mm.

The volume resistivity is measured by machining to a diameter of 20 mm and a thickness of 2 mm using the DC three-terminal method in accordance with JIS C2141:1992.

The specific heat capacity is measured by DSC (differential scanning calorimetry). A sample of diameter 6 mm×thickness 0.75 mm is used.

Thermal diffusivity is measured by the laser flash method. A sample of diameter 10 mm×thickness 2.0 mm is used.

The thermal conductivity λ is calculated from the specific heat capacity Cp, density p, and thermal diffusivity a by the formula: λ=Cp×ρ×α.

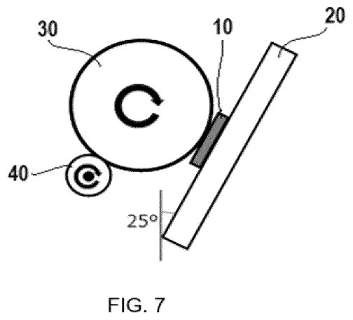

The polishing rate is evaluated based on a depth of polishing marks measured using a Calotest, the outline of which is schematically shown in FIG. 7. The deeper the polishing marks, the faster the polishing rate. For example, a Calotest manufactured by Anton Paar is used as the Calotest.

A silicon nitride-type sintered body is cut out, and a sample 10 having a thickness of 2 mm, with a mirror-finished evaluation surface is affixed to a surface plate 20. A steel ball 30 having a diameter of 30 mm (which is a precision ball, for example, an SUJ2 ball (JIS grade G60) manufactured by Tsubaki Nakashima Co., Ltd.) is brought into contact with the sample, and while dropping a slurry described below, the ball is rotated on a rotary shaft 40 under the conditions described below. A depth of the depression (polishing marks) formed on the sample 10 is measured using a laser microscope. The measurement is performed three times, and the average value is determined.
Stage angle: 25°-Rotation speed: 1000 rpm
Processing time: 60 sec
Slurry: 0.2 μm diamond abrasive grains
Slurry amount: 3 drops the first time, then 1 drop every 10 seconds

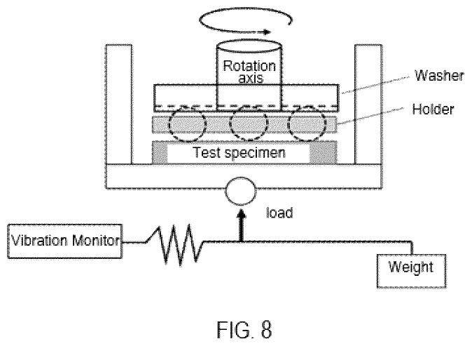

The fatigue test using thrust rolling test is performed under the following conditions. Testing machine: Thrust rolling fatigue testing machine (e.g., manufactured by Fuji Testing Machines Co., Ltd.). FIG. 8 shows a schematic diagram of the thrust rolling testing device.
Maximum Hertzian pressure: 5.2 GPa
Spindle speed: 1200 rpm
Sphere size and number: diameter of ⅜ inch, 6 pieces
Environment: Oil lubrication (e.g. Kurisef Oil F8 manufactured by JX Nippon Mining & Metals Corporation)
Test piece: SUJ2 flat plate
Stopping conditions: When 108 rotations are reached or when vibration increases due to spalling. However if no spalling is visually observed on the rolling element, the SUJ2 plate is replaced and the test is continued.

In the thrust rolling test, the number of rotations at the time of stoppage is measured.

### <Silicon Nitride-Type Sintered Body>

The first silicon nitride-type sintered body in the present disclosure contains 3.0% by mass or more of Al and 3.0% by mass or more of O, in which a proportion of a β phase is from 5 to 100%, and the proportion of β phase is expressed as (β(101)+β(120))/(α(210)+α(201)+β(101)+β(120))×100, and calculated from heights of peaks corresponding to an α phase (210), an α phase (201), an β phase (101), and an β phase (120) in an X-ray diffraction spectrum. The first silicon nitride-type sintered body having the above configuration has a reduced surface-altered layer caused by sintering.

As a sintered composition for the silicon nitride-type sintered body, silicon nitride-aluminum oxide and silicon nitride-rare earth oxide-aluminum oxide-titanium oxide systems and the like are generally known. In order to densify the sintered body and increase its strength, a sintering aid such as a rare earth oxide are used. The sintering aid generates a grain boundary phase including Si-rare earth element-Al—O—N and the like during sintering.

However, in a case in which a sintering aid is used, a part of the oxygen contained in the sintering aid evaporates during sintering, and gas is generated. In a case in which the gas remains in the silicon nitride-type sintered body, a white spot-like defect called snowflake occurs. Since the snowflake is a region derived from the gas, the density thereof is lower than that of the surrounding area.

In contrast, the first silicon nitride-type sintered body in the present disclosure is less likely to generate snowflakes due to the above-described configuration.

It should be noted that a silicon nitride-type sintered body having a defect such as a snowflake requires a process for filling the defect by hot isostatic pressing (HIP), which increases the manufacturing cost. In addition, since such a defect is likely to occur near the surface layer of the silicon nitride-type sintered body, a grinding process of the surface layer is required, which also increases the manufacturing cost.

The first silicon nitride-type sintered body in the present disclosure has the configuration of <1> below; and preferably further has the configurations of <2> to <12> below:
<1> A silicon nitride-type sintered body containing 3.0% by mass or more of Al and 3.0% by mass or more of O, in which a proportion of a β phase is from 5 to 100%, and the proportion of β phase is expressed as (β(101)+β(120))/(α(210)+α(201)+β(101)+β(120))×100, and calculated from heights of peaks corresponding to an α phase (210), an α phase (201), an β phase (101), and an β phase (120) in an X-ray diffraction spectrum.
<2> The silicon nitride-type sintered body according to <1>, containing 1% by mass or more of at least one of Mg, Ca, or Y.
<3> The silicon nitride-type sintered body according to <1> or <2>, containing 1% by mass or more of Ca.
<4> The silicon nitride-type sintered body according to any one of <1> to <3>, in which no defects with a major axis of 30 μm or more are observed when a region, having a unit area of 5 mm×5 mm, of a cross section of the silicon nitride-type sintered body is observed under a bright field magnified from 10 to 200 times with an optical microscope.
<5> The silicon nitride-type sintered body according to any one of <1> to <4>, in which no snowflakes with a major axis of 25 μm or more are observed when a region of a unit area of 5 mm×5 mm of a cross section of the silicon nitride-type sintered body is observed under a dark field magnified from 10 to 200 times with an optical microscope.
<6> The silicon nitride-type sintered body according to any one of <1> to <5>, in which no snowflakes with a major axis of 50 μm or more are observed when a region of a cross section of the silicon nitride-type sintered body within 250 μm inward from a surface of the sintered body is observed under a dark field magnified from 10 to 200 times with an optical microscope.
<7> A silicon nitride-type sintered body according to any one of <1> to <6>, in which no sintered altered layer including a snowflake with a major axis of 50 μm or more are observed when a region of a cross section of the silicon nitride-type sintered body within 250 μm inward from a surface of the sintered body is observed under a dark field magnified from 10 to 200 times with an optical microscope.
<8> A silicon nitride-type sintered body according to any one of <1> to <7>, having a fracture toughness value of 5.0 MPa·m^{1/2} or more.
<9> A silicon nitride-type sintered body according to any one of <1> to <8>, having which a Young's modulus of 270 GPa or more.
<10> A silicon nitride-type sintered body according to any one of <1> to <9>, including SiAlON in solid solution form.
<11> The silicon nitride-type sintered body according to any one of <1> to <10>, in which a crushing strength of the silicon nitride-type sintered body in a spherical shape having a diameter of 10 mm is 15 kN or more, a the Weibull modulus of the crushing strength is 7 or more.
<12> The silicon nitride-type sintered body according to any one of <1> to <11>, in which peaks corresponding to a β phase are present at 177±2 cm⁻¹, 192±5 cm⁻¹, and 219±3 cm⁻¹ in the Raman spectroscopy spectrum.

The first silicon nitride-type sintered body contains 3.0% by mass or more of Al. The content of Al in the first silicon nitride-type sintered body is preferably 3.5% by mass or more, preferably 4.0% by mass or more, preferably 4.5% by mass or more, preferably 5.0% by mass or more, preferably 5.5% by mass or more, and preferably 6.0% by mass.

From the viewpoint of improving fracture toughness, the content of Al in the first silicon nitride-type sintered body is preferably 15% by mass or less, preferably 14% by mass or less, preferably 12% by mass or less, preferably 11% by mass or less, preferably 10% by mass or less, preferably 9.0% by mass or less, preferably 8.5% by mass or less, preferably 8.0% by mass or less, preferably 7.5% by mass or less, and preferably 7.0% by mass or less.

The first silicon nitride-type sintered body contains 3.0% by mass or more of O. The content of O in the first silicon nitride-type sintered body is preferably 3.5% by mass or more, preferably 4.0% by mass or more, preferably 4.5% by mass or more, preferably 5.0% by mass or more, preferably 5.5% by mass or more, and preferably 6.0% by mass.

From the viewpoint of improving fracture toughness, the content of O in the first silicon nitride-type sintered body is preferably 15% by mass or less, preferably 14% by mass or less, preferably 12% by mass or less, preferably 11% by mass or less, preferably 10% by mass or less, preferably 9.0% by mass or less, preferably 8.5% by mass or less, preferably 8.0% by mass or less, preferably 7.5% by mass or less, and preferably 7.0% by mass or less.

A content of Si in the first silicon nitride-type sintered body is preferably 30% by mass or more, preferably 40% by mass or more, preferably 42% by mass or more, preferably 43% by mass or more, preferably 44% by mass or more, and preferably 45% by mass or more.

The content of O in the first silicon nitride-type sintered body is preferably 60% by mass or less, preferably 58% by mass or less, preferably 56% by mass or less, preferably 54% by mass or less, preferably 52% by mass or less, preferably 50% by mass or less, preferably 49% by mass or less, preferably 48% by mass or less, preferably 47% by mass or less, preferably 46% by mass or less.

A content of Ni in the first silicon nitride-type sintered body is preferably 25% by mass or more, preferably 27% by mass or more, preferably 29% by mass or more, preferably 31% by mass or more, preferably 33% by mass or more, preferably 34% by mass.

The content of N in the first silicon nitride-type sintered body is preferably 45% by mass or less, preferably 43% by mass or less, preferably 42% by mass or less, preferably 41% by mass or less, preferably 40% by mass or less, preferably 39% by mass or less, preferably 38% by mass or less, preferably 37% by mass or less, preferably 36% by mass or less, and preferably 35% by mass or less.

In the first silicon nitride-type sintered body, a proportion of a β phase with respect to a total of an α-phase and a β-phase, which is calculated from heights of peaks corresponding to α-phase (210), α-phase (201), β-phase (101), and β-phase (120) in an X-ray diffraction spectrum, is from 5 to 100%.

Hereinafter, the a proportion of a β phase with respect to a total of the α-phase and β-phase: β phase/(α phase+β phase)×100: is also referred to as a β ratio (%). In addition, a proportion of an α-phase with respect to a total of the α phase and the β phase: α phase/(a phase+β phase)×100 is also referred to as an α ratio (%).

In the present disclosure, as main peaks representing the α-phase in the X-ray diffraction spectrum, the peaks corresponding to α-phase (210) and α-phase (201) are used, and as main peaks representing the β-phase, the peaks corresponding to β-phase (101) and β-phase (120) are used. In the X-ray diffraction spectrum, the peak corresponding to α-phase (210) appears at 2θ=from 30.5° to 32°, the peak corresponding to α-phase (201) appears at 2θ=from 35° to 36°, the peak corresponding to β-phase (101) appears at 2θ=from 33° to 34°, and the peak corresponding to β-phase (120) appears at 2θ=from 36° to 37°.

In the present disclosure, the β ratio is calculated from the following formula.

$$β ratio = ( β ( 101 ) + β ( 120 ) ) / ( α ( 210 ) + α ( 201 ) + β ( 101 ) + β ( 120 ) ) \times 100$$

In the above formula, α(201) is the maximum value of the peak height in the range of 2θ=from 30.5 to 32°, α(210) is the maximum value of the peak height in the range of 2θ=from 35 to 36°, β(101) is the maximum value of the peak height in the range of 2θ=from 33 to 34°, and β(120) is the maximum value of the peak height in the range of 2θ=from 36 to 37°. An average value of 2θ=from 32 to 35° is taken as a baseline.

The B ratio of the first silicon nitride-type sintered body is 5% or more, preferably 10% or more, preferably 20% or more, preferably 30% or more, preferably 40% or more, preferably 50% or more, and preferably 60% or more. The β ratio is 100% or less, preferably 95% or less, preferably 90% or less, preferably 85% or less, preferably 80% or less, preferably 75% or less, and preferably 70% or less.

The first silicon nitride-type sintered body preferably contains 1% by mass or more of at least one of Mg, Ca, or Y.

The first silicon nitride-type sintered body may or may not contain Mg. In a case in which the first silicon nitride-type sintered body contains Mg, a content of Mg in the first silicon nitride-type sintered body is preferably 0.1% by mass or more, preferably 0.5% by mass or more, preferably 1.0% by mass or more, preferably 1.5% by mass or more, preferably 2.0% by mass or more, and preferably 2.5% by mass or more. Furthermore, the content of Mg in the first silicon nitride-type sintered body is preferably 6.0% by mass or less, preferably 5.0% by mass or less, preferably 4.0% by mass or less, and preferably 3.0% by mass or less.

The first silicon nitride-type sintered body may or may not contain Ca, and preferably contains Ca from the viewpoint of promoting grain boundary sintering. In a case in which the first silicon nitride-type sintered body contains Ca, a content of Ca in the first silicon nitride-type sintered body is preferably 1.0% by mass or more, more preferably 1.5% by mass or more, even more preferably 2.0% by mass or more, and preferably 2.5% by mass or more. Furthermore, from the viewpoint of strength, the content of Ca in the first silicon nitride-type sintered body is preferably 10% by mass or less, preferably 9.0% by mass or less, preferably 8.0% by mass or less, preferably 7.0% by mass or less, preferably 6.0% by mass or less, preferably 5.0% by mass or less, preferably 4.0% by mass or less, and preferably 3.0% by mass or less. The first silicon nitride-type sintered body in the present disclosure preferably contains 1.0% by mass or more of Ca.

The first silicon nitride-type sintered body may or may not contain Y. In a case in which the first silicon nitride-type sintered body contains Y, a content of Y in the first silicon nitride-type sintered body may be 1.0% by mass or more, 1.5% by mass or more, 2.0% by mass or more, or 2.5% by mass or more. Furthermore, the content of Y in the first silicon nitride-type sintered body may be 10% by mass or less, 9.0% by mass or less, 8.0% by mass or less, 7.0% by mass or less, 6.0% by mass or less, 5.0% by mass or less, 4.0% by mass or less, or 3.0% by mass or less.

In the first silicon nitride-type sintered body preferably, a total content of Mg, Ca and Y is preferably 1.0% by mass or more, may be 1.5% by mass or more, may be 2.0% by mass or more, may be 2.5% by mass or more, or may be 3.0% by mass or more. Furthermore, the total content of Mg, Ca and Y may be 10% by mass or less, may be 9.0% by mass or less, may be 8.0% by mass or less, may be 7.0% by mass or less, may be 6.0% by mass or less, may be 5.0% by mass or less, may be 4.0% by mass or less, or may be 3.5% by mass or less.

The first silicon nitride-type sintered body is more preferably SiAlON which is an oxynitride. SiAlON is considered to have a structure in which N in silicon nitride (Si₃N₄) is partially substituted with O, and Si is partially substituted with Al. SiAlON includes αSiAlON, which has an α phase, and βSiAlON, which has a β phase. αSiAlON is considered to have a structure in which a metal atom M (M=Li, Mg, Ca, Y, La, or the like) is present inside the crystal lattice. βSiAlON does not have a metal atom M inside the crystal lattice.

In the Raman spectrum of the first silicon nitride-type sintered body in the present disclosure, it is preferable that peaks corresponding to the β phase are present at 177±2 cm⁻¹ (also referred to as around 177 cm⁻¹), 192±5 cm⁻¹ (also referred to as around 192 cm⁻¹), and 219±3 cm⁻¹ (also referred to as around 219 cm⁻¹), and the peaks near 177 cm⁻¹ and 192 cm⁻¹ are preferably broad.

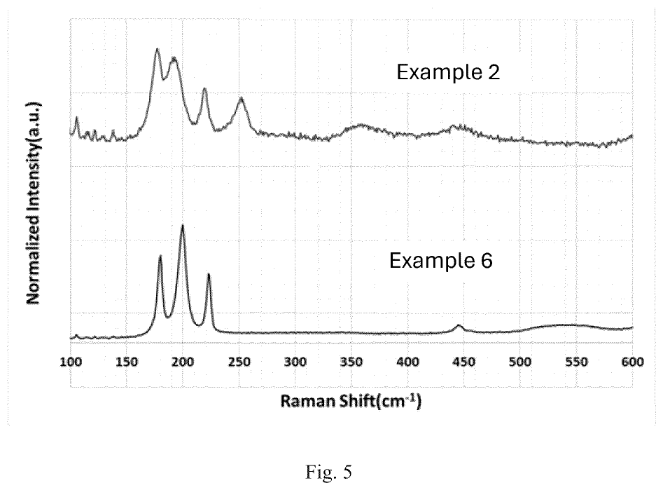

FIG. 5 (A) shows a Raman spectrum of an example of the first silicon nitride-type sintered body in the present disclosure (this is Example 2 described in the Examples below). FIG. 5(B) shows a Raman spectrum of an example of a conventional silicon nitride-type sintered body (this is Example 6 described in the Examples below).

As shown in FIG. 5(A), the first silicon nitride-type sintered body in the present disclosure has peaks near 177 cm⁻¹, 192 cm⁻¹, and 219 cm⁻¹. These peaks correspond to the β phase of the silicon nitride-type sintered body. In the Raman spectrum shown in FIG. 5(A), the peaks near 177 cm⁻¹ and 192 cm⁻¹ are broad, indicating that the first silicon nitride-type sintered body is in a solid solution form. This suggests that a large amount of Al and O (oxygen) are in a solid solution form and a crystallinity is low:

In contrast, as shown in FIG. 5(B), the conventional silicon nitride-type sintered body has sharp peaks corresponding to the β phase at 180 cm⁻¹, 200 cm⁻¹, and 223 cm⁻¹. In the Raman spectrum shown in FIG. 5(B), these peaks are sharp, indicating that the silicon nitride-type sintered body is not in a solid solution form.

Whether the peaks near 177 cm⁻¹ and 192 cm⁻¹ in the Raman spectrum are broad can be confirmed from the ratio of the maximum peak intensity at from 170 to 190 cm⁻¹ to the minimum peak intensity at from 177 to 197 cm⁻¹. In a case in which the ratio is from 1.0 to 3.0, it can be considered to be a solid solution form. The ratio is preferably 1.0 or more, preferably 1.1 or more, preferably 1.2 or more, preferably 1.3 or more, preferably 1.4 or more, and preferably 1.5 or more. The ratio is preferably 4 or less, preferably 3.5 or less, preferably 3.0 or less, preferably 2.5 or less, preferably 2.0 or less, preferably 1.9 or less, and preferably 1.8 or less.

The Raman spectrum shown in FIG. 5(A) is a Raman spectrum of an example of the second silicon nitride-type sintered body (this is Example 2 described in the Examples below), and the peak having a peak top at 170 to 190 cm 1 is considered to be a broad peak, since the ratio to the minimum value at 177 to 197 cm 1 is 1.26, indicating that it is in a solid solution form.

In contrast, in the silicon nitride-type sintered body shown in FIG. 5 (B), the peak having a peak top at 170 to 190 cm 1 is considered to be a shape peak, since the ratio to the minimum value at 177 to 197 cm 1 is more than 3.0, indicating that it is not in a solid solution form.

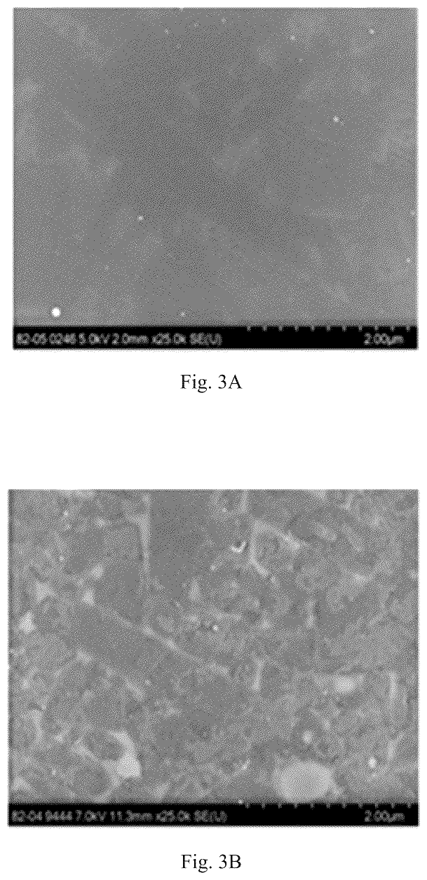

As the first silicon nitride-type sintered body, SiAlON in a solid solution form is preferable. In the present disclosure, whether or not the silicon nitride-type sintered body is in a solid solution form is confirmed by Raman spectroscopy as described above, but may be additionally confirmed by a scanning electron microscope (SEM, for example, IM4000plus manufactured by Hitachi High-Technologies Corporation). For example, as shown in FIG. 3, in the silicon nitride-type sintered body represented by (B), it is confirmed that the matrix phase and the grain boundary phase are clearly separated, but in the sintered body represented by (A), it is confirmed that the matrix phase and the grain boundary phase are not clearly separated and the sintered body is in a solid solution form. In a case in which the first silicon nitride-type sintered body is in a solid solution form, a region of the grain boundary phase with low mechanical strength is reduced, and therefore the mechanical strength is improved. In addition, in a case in which a region of the grain boundary phase is small, an occurrence of the snowflake tends to be further suppressed.

Note that conventional silicon nitride-type sintered bodies are obtained by adding a sintering aid such as Al₂O₃ and Y₂O₃ to αSi₃N₄ as a raw material and sintering the mixture. Since αSi₃N₄ alone does not form a solid solution even at high temperatures, the grain boundary phase derived from the sintering aid fills the grain boundaries of αSi₃N₄. In conventional silicon nitride-type sintered bodies in which the matrix phase and the grain boundary phase are clearly separated, a sufficient amount of sintering aid is required in order to obtain a dense sintered body. Since this grain boundary phase tends to be a cause of snowflakes, which may reduce wear resistance, it is preferable that the grain boundary phase is not present in an excessive amount.

Furthermore, in conventional silicon nitride-type sintered bodies, in a case in which an excessive amount of O (oxygen) is contained, crystal grains grow and defects at the grain boundaries increase, leading to a decrease in strength. Therefore, the O content is less than 3% by mass.

The first silicon nitride-type sintered body in the present disclosure is unlikely to generate a pore having a major axis of 30 μm or more, and it is preferable that no pores having a major axis of 30 μm or more are confirmed when a region of 5×5 mm in unit area is observed under a bright field condition at a magnification of from 10 to 200 times using an optical microscope.

The maximum major axis of the pore is preferably 30 μm or less, preferably 25 μm or less, preferably 20 μm or less, preferably 15 μm or less, preferably 12 μm or less, and preferably 10 μm or less.

In the first silicon nitride-type sintered body in the present disclosure, a snowflake having a major axis of 50 μm or more are unlikely to occur, and it is preferable that no snowflakes having a major axis of 25 μm or more are confirmed when a region of 5×5 mm in unit area is observed under a dark field condition at a magnification of from 10 to 200 times using an optical microscope.

The maximum major axis of the snowflake in the first silicon nitride-type sintered body is preferably 50 μm or less, preferably 40 μm or less, preferably 30 μm or less, preferably 20 μm or less, preferably 15 μm or less, preferably 12 μm or less, and preferably 10 μm or less.

In general, silicon nitride-type sintered bodies are likely to generate snowflakes, particularly in the vicinity of the surface. However, the first silicon nitride-type sintered body of the present disclosure is less likely to generate a snowflake even in the vicinity of the surface, so that the surface cutting amount (grinding margin) for removing the snowflake is reduced, and the manufacturing cost is suppressed. It is preferable that, when the region within 250 μm from the surface toward the interior (also referred to as the outer peripheral portion) of the first silicon nitride-type sintered body is observed under dark-field conditions at a magnification of 10 to 200 times using an optical microscope, no snowflakes having a major axis of 50 μm or more are present in the magnified image.

The maximum major axis of the snowflake in the outer periphery of the first silicon nitride-type sintered body is preferably 50 μm or less, preferably 40 μm or less, preferably 30 μm or less, and preferably 20 μm or less.

The first silicon nitride-type sintered body in the present disclosure preferably does not have a sintered altered layer in a region within 250 μm inward from the surface (also called the outer periphery). The sintered altered layer is defined as a region in which a snowflake having a major axis of 50 μm or more is present when a region within 250 μm inward from a surface of the sintered body before surface processing is observed in a dark field at a magnification of 10 to 200 times with an optical microscope.

A fracture toughness value of the first silicon nitride-type sintered body is preferably 5.0 MPa·m^{1/2} or more, preferably 5.2 MPa·m^{1/2} or more, preferably 5.4 MPa·m^{1/2} or more, preferably 5.6 MPa·m^{1/2} or more, preferably 5.8 MPa·m^{1/2} or more, preferably 6.0 MPa·m^{1/2} or more, preferably 6.3 MPa·m^{1/2} or more, preferably 6.5 MPa·m^{1/2} or more, and preferably 7.0 MPa·m^{1/2} or more.

An upper limit of the first fracture toughness value is not particularly limited, and may be 10.0 MPa·m^{1/2} or less, 9.0 MPa·m^{1/2} or less, 8.0 MPa·m^{1/2} or less, or 7.5 MPa·m^{1/2} or less.

A Young's modulus of the first silicon nitride-type sintered body is preferably 270 GPa or more, preferably 280 GPa or more, preferably 290 GPa or more, and preferably 300 GPa or more. An upper limit of the Young's modulus is not particularly limited, and may be 350 GPa or less, 340 GPa or less, 330 GPa or less, 320 GPa or less, 315 GPa or less, or 310 GPa or less.

A density of the first silicon nitride-type sintered body is preferably 3.00 g/cm³ or more, preferably 3.05 g/cm³ or more, preferably 3.10 g/cm³ or more, preferably 3.15 g/cm³ or more, preferably 3.17 g/cm³ or more, and preferably 3.19 g/cm³ or more. An upper limit of the density is preferably 3.40 g/cm³ or less, more preferably 3.30 g/cm³ or less, even more preferably 3.25 g/cm³ or less, particularly preferably 3.20 g/cm³ or less, and may be 3.19 g/cm³ or less, 3.18 g/cm³ or less, 3.17 g/cm³ or less, or 3.16 g/cm³ or less.

A thermal expansion coefficient of the first silicon nitride-type sintered body is preferably 3.5 ppm or less, preferably 3.4 ppm or less, preferably 3.3 ppm or less, preferably 3.2 ppm or less, preferably 3.1 ppm or less, or preferably 3.0 ppm or less. The lower limit of the thermal expansion coefficient is not particularly limited, and may be 2.5 ppm or more, 2.6 ppm or more, 2.7 ppm or more, 2.8 ppm or more, or 2.9 ppm or more.

The first silicon nitride-type sintered body is preferably an insulator, and a volume resistivity at room temperature (25° C.) is preferably 1×10¹⁰ Ω·cm or more, preferably 1×10¹¹ Ω·cm or more, preferably 1×10¹² Ω·cm or more, preferably 1×10¹³ Ω·cm or more, preferably 1×10¹⁴ Ω·cm or more, preferably 1×10¹⁵ Ω·cm or more, and most preferably 1×10¹⁶ Ω·cm or more.

The first silicon nitride-type sintered body preferably has higher thermal insulation performance, and a thermal conductivity is preferably 50 W/(m·K) or less, preferably 40 W/(m·K) or less, preferably 30 W/(m·K) or less, preferably 25 W/(m·K) or less, preferably 20 W/(m·K) or less, preferably 15 W/(m·K) or less, and preferably 10 W/(m·K) or less. For example, in a case in which it is used as a bearing rolling element, a temperature of the rolling element is likely to rise due to frictional resistance between the outer and inner rings at high speed rotation. Therefore, from the viewpoint of suppressing the temperature rise due to frictional resistance, it is preferable that the thermal conductivity of the rolling element is small, which is expected to suppress the increase in friction due to thermal deformation. The first silicon nitride-type sintered body tends to have a low thermal conductivity.

A Vickers hardness of the first silicon nitride-type sintered body is preferably 1300 GPa or more, preferably 1350 GPa or more, preferably 1370 GPa or more, preferably 1400 GPa or more, preferably 1420 GPa or more, and preferably 1450 GPa or more. An upper limit of the Vickers hardness is not particularly limited, and may be 2000 GPa or less, 1900 GPa or less, 1800 GPa or less, 1700 GPa or less, 1600 GPa or less, or 1550 GPa or less.

The first silicon nitride-type sintered body preferably has a crushing strength of 15 kN or more when formed into a sphere having a diameter of 10 mm, and a Weibull modulus of the crushing strength of 7 or more.

The crushing strength of the first silicon nitride-type sintered body is preferably 15 kN or more, preferably 16 kN or more, preferably 17 kN or more, preferably 18 kN or more, preferably 19 kN or more, and preferably 20 kN or more. An upper limit of the crushing strength is not particularly limited, and may be 40 kN or less, 35 kNa or less, 30 kN or less, 28 KN or less, 25 kN or less, or 24 kN or less.

Furthermore, a Weibull modulus of the crushing strength of the first silicon nitride-type sintered body is preferably 7 or more, preferably 8 or more, preferably 9 or more, preferably 11 or more, preferably 12 or more, and preferably 13 or more. An upper limit of the Weibull modulus of the crushing strength is not particularly limited, and may be 40 or less, 30 or less, 25 or less, 20 or less, 18 or less, or 15 or less.

An three-point bending strength of the first silicon nitride-type sintered body is preferably 500 MPa·m^{1/2} or more, preferably 600 MPa·m^{1/2} or more, preferably 700 MPa·m^{1/2} or more, preferably 750 MPa·m^{1/2} or more, preferably 800 MPa·m^{1/2} or more, and preferably 850 MPa·m^{1/2} or more. An upper limit of the three-point bending strength is not particularly limited, and may be 1200 MPa·m^{1/2} or less, 1100 MPa·m^{1/2} or less, 1050 MPa·m^{1/2} or less, 1000 MPa·m^{1/2} or less, 980 MPa·m^{1/2} or less, or 930 MPa·m^{1/2} or less.

Furthermore, a Weibull modulus of three-point bending strength of the first silicon nitride-type sintered body is preferably 5 or more, preferably 6 or more, preferably 7 or more, preferably 8 or more, preferably 9 or more, and preferably 10 or more. An upper limit of the Weibull modulus of three-point bending strength is not particularly limited, and may be 15 or less, 14 or less, 13 or less, 12 or less, or 11 or less.

### <Second Silicon Nitride-Type Sintered Body>

The second silicon nitride-type sintered body in the present disclosure has a total content of at least one metal M selected from the group consisting of Mg, Ca and Y of from 0.2 to 8.0% by mass, an Al content of from 4.0 to 12.0% by mass, an O content of from 4.0 to 12.0% by mass, and a fracture toughness value of from 5.0 to 10.0 MPa·m^{1/2}. The second silicon nitride-type sintered body having the above configuration is characterized by excellent machinability.

The second silicon nitride-type sintered body has a total content of metal M of 0.2% by mass or more, preferably 0.5% by mass or more, more preferably 1.0% by mass or more, more preferably 1.5% by mass or more, and even more preferably 2.0% by mass or more. Furthermore, the second silicon nitride-type sintered body has a total content of metal M of 8.0% by mass or less, preferably 7.5% by mass or less, preferably 7.0% by mass or less, preferably 6.5% by mass or less, preferably 6.0% by mass or less, preferably 5.5% by mass or less, preferably 5.0% by mass or less, preferably 4.5% by mass or less, preferably 4.0% by mass or less, preferably 3.5% by mass or less, and preferably 3.0% by mass or less.

From the viewpoints of improving fracture toughness and having a small density, it is preferable that the metal M of the second silicon nitride-type sintered body is Ca.

In a case in which the second silicon nitride-type sintered body contains Ca, a Ca content in the second silicon nitride-type sintered body is preferably 0.2% by mass or more, preferably 0.5% by mass or more, preferably 1.0% by mass or more, may be 1.5% by mass or more, may be 2.0% by mass or more, may be 2.5% by mass or more, may be 3.0% by mass or more, or may be 3.5% by mass or more. From the viewpoint of strength, the Ca content in the second silicon nitride-type sintered body is 8.0% by mass or less, may be 7.5% by mass or less, may be 7.0% by mass or less, may be 6.5% by mass or less, may be 6.0% by mass or less, may be 5.5% by mass or less, may be 5.0% by mass or less, may be 4.5% by mass or less, may be 4.0% by mass or less, or may be 3.5% by mass or less.

The second silicon nitride-type sintered body may or may not contain Mg. In a case in which the second silicon nitride-type sintered body contains Mg, a content of Mg in the second silicon nitride-type sintered body may be 0.1% by mass, 0.5% by mass or more, 1.0% by mass or more, 1.5% by mass or more, 2.0% by mass or more, or 2.5% by mass or more. The content of Mg in the second silicon nitride-type sintered body is 8.0% by mass or less, may be 7.5% by mass or less, may be 7.0% by mass or less, may be 6.5% by mass or less, may be 6.0% by mass or less, may be 5.5% by mass or less, may be 5.0% by mass or less, may be 4.5% by mass or less, may be 4.0% by mass or less, or may be 3.5% by mass or less.

The second silicon nitride-type sintered body may or may not contain Y. In a case in which the second silicon nitride-type sintered body contains Y, a content of Y in the second silicon nitride-type sintered body may be 1.0% by mass or more, 1.5% by mass or more, 2.0% by mass or more, or 2.5% by mass or more. The content of Y in the second silicon nitride-type sintered body is 8.0% by mass or less, may be 7.5% by mass or less, may be 7.0% by mass or less, may be 6.5% by mass or less, may be 6.0% by mass or less, may be 5.5% by mass or less, may be 5.0% by mass or less, may be 4.5% by mass or less, may be 4.0% by mass or less, or may be 3.5% by mass or less.

The second silicon nitride-type sintered body has an Al content of 4.0% by mass or more, and from the viewpoint of sinterability, Al content is preferably 4.5% by mass or more, preferably 5.0% by mass or more, preferably 5.5% by mass or more, preferably 6.0% by mass or more, preferably 6.5% by mass or more, and preferably 7.0% by mass or more. The second silicon nitride-type sintered body has a total Al content of 12.0% by mass or less, preferably 11.5% by mass or less, preferably 11.0% by mass or less, preferably 10.5% by mass or less, preferably 10.0% by mass or less, preferably 9.5% by mass or less, preferably 9.0% by mass or less, preferably 9.5% by mass or less, preferably 9.0% by mass or less, preferably 8.5% by mass or less, preferably 8.0% by mass or less, and preferably 7.5% by mass or less.

The second silicon nitride-type sintered body has an O content of 4.0% by mass or more, and from the viewpoint of machinability, the O content is preferably 4.5% by mass or more, more preferably 5.0% by mass or more, more preferably 5.5% by mass or more, more preferably 6.0% by mass or more, and even more preferably 6.5% by mass or more. The second silicon nitride-type sintered body has the O content of 12.0% by mass or less, and from the viewpoint of improving fracture toughness, the O content is preferably 11.0% by mass or less, preferably 10.0% by mass or less, preferably 9.0% by mass or less, preferably 8.0% by mass or less, and preferably 7.0% by mass or less.

The Si content and N content in the second silicon nitride-type sintered body are the same as the Si content and N content in the first silicon nitride-type sintered body.

The fracture toughness value of the second silicon nitride-type sintered body is 5.0 MPa·m^{1/2} or more, preferably 5.2 MPa·m^{1/2} or more, preferably 5.4 MPa·m^{1/2} or more, preferably 5.6 MPa·m^{1/2} or more, preferably 5.8 MPa·m^{1/2} or more, preferably 6.0 MPa·m^{1/2} or more, preferably 6.3 MPa·m^{1/2} or more, preferably 6.5 MPa·m^{1/2} or more, preferably 7.0 MPa·m^{1/2} or more.

The fracture toughness value of the second silicon nitride-type sintered body is 10.0 MPa·m^{1/2} or less, may be 9.0 MPa·m^{1/2} or less, may be 8.0 MPa·m^{1/2} or less, or may be 7.5 MPa·m^{1/2} or less.

A total content of a metal M in the grain boundary phase is preferably from 2.0 to 40.0% by mass, more preferably from 2.0 to 30.0% by mass, from the viewpoint of improving fracture toughness.

The total content of the metal M in the grain boundary phase may be 3.0% by mass or more, 4.0% by mass or more, 5.0% by mass or more, 6.0% by mass or more, 7.0% by mass or more, 8.0% by mass or more, 9.0% by mass or more, 10.0% by mass or more, or 11.0% by mass or more.

The total content of the metal M in the grain boundary phase may be 25.0% by mass or less, 20.0% by mass or less, 18.0% by mass or less, 17.0% by mass or less, 16.0% by mass or less, 15.0% by mass or less, 14.0% by mass or less, 13.0% by mass or less, or 12.0% by mass or less.

From the viewpoint of improving fracture toughness, a total content of the metal M in the matrix phase is preferably from 2.0 to 10.0% by mass, and more preferably from 2.0 to 8.0% by mass.

The total content of metal M in the matrix phase may be 2.5% by mass or more, 3.0% by mass or more, 3.5% by mass or more, or 4.0% by mass or more.

The total content of metal M in the matrix phase may be 7% by mass or less, 6.5% by mass or less, 6.0% by mass or less, 5.5% by mass or less, 5.0% by mass or less, 4.5% by mass or less, or 4.0% by mass or less.

The second silicon nitride-type sintered body is more preferably a SiAlON in a solid solution form. The term “SiAlON” is synonymous with that described as the first silicon nitride-type sintered body. The term “solid solution form” is also synonymous with that described as the first silicon nitride-type sintered body.

In the second silicon nitride-type sintered body, a ratio of the maximum peak intensity at from 170 to 190 cm⁻¹ to the minimum peak intensity at from 177 to 197 cm⁻¹ in the Raman spectrum is preferably 1.0 to 3.0, and within this range, the SiAlON particles form a solid solution with each other. The ratio is preferably 1.0 or more, preferably 1.1 or more, preferably 1.2 or more, preferably 1.3 or more, preferably 1.4 or more, and preferably 1.5 or more. The ratio is preferably 3.0 or less, preferably 2.5 or less, preferably 2.0 or less, preferably 1.9 or less, and preferably 1.8 or less.

In the Raman spectrum, it is preferable that the peak attributed to the β phase at from 185 to 210 cm⁻¹ is present between from 187 to 199 cm⁻¹.

A thermal conductivity of the second silicon nitride-type sintered body is preferably from 5 to 15 W/(m·K). The thermal conductivity of the second silicon nitride-type sintered body may be 6 W/(m·K) or more, or 7 W/(m·K) or more. The thermal conductivity of the second silicon nitride-type sintered body may be 14 W/(m·K) or less, 13 W/(m·K) or less, or 12 W/(m·K) or less.

A density of the second silicon nitride-type sintered body is preferably from 3.10 to 3.20 g/cm³. The density of the second silicon nitride-type sintered body may be 3.11 g/cm³ or more, 3.12 g/cm³ or more, or 3.13 g/cm³ or more. The density of the second silicon nitride-type sintered body may be 3.19 g/cm³ or less, 3.18 g/cm³ or less, 3.17 g/cm³ or less, or 3.16 g/cm³ or less.

In the second silicon nitride-type sintered body, a proportion of a β phase with respect to a total of an α-phase and a β-phase, which is calculated from heights of peaks corresponding to α-phase (210), α-phase (201), β-phase (101), and β-phase (120) in an X-ray diffraction spectrum, is preferably from 5 to 100%.

The β ratio (%) and α ratio (%) of the second silicon nitride-type sintered body are the same as the β ratio (%) and α ratio (%) of the first silicon nitride-type sintered body, respectively.

The second silicon nitride-type sintered body in the present disclosure is unlikely to generate a pore having a major axis of 10 μm or more, and it is preferable that no defects having a major axis of 10 μm or more are confirmed when a region of 5×5 mm in unit area is observed under a bright field condition at a magnification of from 10 to 200 times using an optical microscope.

The maximum major axis of the defect is preferably 10 μm or less, preferably 9 μm or less, preferably 8 μm or less, preferably 7 μm or less, preferably 6 μm or less, and preferably 5 μm or less.

The second silicon nitride-type sintered body in the present disclosure is unlikely to generate a snowflake having a major axis of 25 μm or more, and it is preferable that no snowflakes having a major axis of 25 μm or more are confirmed when a region of 5×5 mm in unit area is observed under a dark field condition at a magnification of from 10 to 200 times using an optical microscope.

The maximum major axis of the snowflake is preferably 20 μm or less, preferably 15 μm or less, and preferably 10 μm or less.

It is preferable that, when the region within 250 μm from the surface toward the interior (also referred to as the outer peripheral portion) of the second silicon nitride-type sintered body is observed under dark-field conditions at a magnification of 10 to 200 times using an optical microscope, no snowflakes having a major axis of 50 μm or more are present in the magnified image.

The maximum major axis of the snowflake in the outer periphery of the second silicon nitride-type sintered body is preferably 50 μm or less, preferably 40 μm or less, preferably 30 μm or less, and preferably 20 μm or less.

In the second silicon nitride-type sintered body, from the viewpoint of machinability, a depth of a polishing mark as an index of a polishing rate measured by a Calotest is preferably 3.6 μm or more, more preferably 3.7 μm or more, more preferably 3.8 μm or more, more preferably 3.9 μm or more, more preferably 4.0 μm or more, more preferably 4.1 μm or more, still more preferably 4.2 μm or more, even more preferably 4.3 μm or more, preferably 4.4 μm or more, more preferably 4.5 μm or more, and still more preferably 4.6 μm or more.

In the second silicon nitride-type sintered body, from the viewpoint of wear resistance, the depth of a polishing mark as an index of the polishing rate measured by a Calotest is preferably 8.0 μm or less, preferably 7.0 μm or less, preferably 6.0 μm or less, preferably 5.0 μm or less, preferably 4.9 or less, preferably 4.8 μm or less, and preferably 4.7 μm or less.

The Young's modulus, thermal expansion coefficient, volume resistivity, Vickers hardness, crushing strength, Weibull modulus of crushing strength, three-point bending strength, and Weibull modulus of three-point bending strength in the second silicon nitride-type sintered body are similar to those of the first silicon nitride-type sintered body.

### <Applications>

The first silicon nitride-type sintered body and the second silicon nitride-type sintered body (hereinafter, the first silicon nitride-type sintered body and the second silicon nitride-type sintered body are collectively referred to as a silicon nitride-type sintered body) are suitably used for applications of wear-resistant members, for example, as bearing rolling elements.

### <Method of Producing Silicon Nitride-Type Sintered Body>

A method of manufacturing the first silicon nitride-type sintered body is not particularly limited as long as it can obtain a sintered body containing 3% by mass or more of Al and 3% by mass or more of O and having a β ratio of from 5 to 100%.

A method of manufacturing the second silicon nitride-type sintered body is not particularly limited as long as it can obtain a sintered body having a total content of at least one metal M selected from the group consisting of Mg, Ca and Y of from 0.2 to 8.0% by mass, an Al content of from 4.0 to 12.0% by mass, an O content of from 4.0 to 12.0% by mass, and a fracture toughness value of from 5.0 to 10.0 MPa·m^{1/2}.

One example of a method of producing a silicon nitride-type sintered body includes: preparing a raw material composition containing a silicon nitride-type material as a raw material; granulating; molding; pressing; degreasing; and sintering. Examples of additives to be added to the raw material composition include a sintering aid, a binder, a solvent, and a sintering accelerator. Processes other than sintering may be omitted as appropriate. In addition, processes other than the above, such as classification, may be added as appropriate.

Examples of another example of a method of producing a silicon nitride-type sintered body include a method in which a silicon nitride-type material as a raw material is sintered alone. However, when attempting to obtain a molded silicon nitride-type sintered body, it is preferable to prepare and use a raw material composition.

Examples of the silicon nitride-type material as raw materials include αSi₃N₄, βSi₃N₄, M-αSiAlON, and βSiAlON. From the viewpoint of sinterability, αSi₃N₄ and M-αSiAlON are preferred, and from the viewpoints of low or no hydrolysis and the allowing the use solvents containing oxygen such as water, βSiAlON or M-αSiAlON are preferred. From the viewpoint of improving fracture toughness by transitioning from granular α-phase crystals to needle-like β-phase crystals during liquid phase sintering, M-αSiAlON is preferred as the silicon nitride-type material as a raw material. In addition, from the viewpoint that the use of a sintering aid can be omitted and a homogeneous and dense silicon nitride-type sintered body in a solid solution form can be obtained, M-αSiAlON is also preferable as the silicon nitride-type material used as the raw material. M-αSiAlON is an αSiAlON in which metal atoms M (M=Li, Mg, Ca, Y, La, or the like.) is present in the crystal lattice, and during the transformation to βSiAlON in liquid phase sintering, the metal atom forms a grain boundary phase with Si, Al, O or the like to obtain a uniform and dense sintered body. The silicon nitride-type material as the raw material may be used alone or in combination of two or more types.

M-αSiAlON may be a commercially available product or may be manufactured. M-αSiAlON is obtained by sintering a mixture of αSi₃N₄, AlN, Al₂O₃, and metal M or a compound containing metal M. Alternatively, M-αSiAlON is synthesized by a combustion synthesis method using raw material powders in which predetermined elements are mixed in a predetermined ratio.

A metal atom M in M-αSiAlON may function as a sintering aid in sintering. Therefore, a content of the metal atom M in M-αSiAlON is preferably 0.5% by mass or more, preferably 1.0% by mass or more, preferably 1.5% by mass or more, preferably 2.0% by mass or more, and preferably 2.5% by mass.

From the viewpoint of suppressing a precipitation of crystal phases other than M-αSiAlON, the content of the metal atom M in M-αSiAlON is preferably 9.0% by mass or less, preferably 8.0% by mass or less, preferably 7.0% by mass or less, preferably 6.0% by mass or less, preferably 5.5% by mass or less, preferably 5% by mass or less, preferably 4.5% by mass or less, and preferably 4.0% by mass or less.

M-α-SiAlON is more preferable as the amount of the α-phase increases. The a phase SiAlON has better sinterability than the β phase SiAlON. An α ratio of M-αSiAlON is preferably 81% or more, more preferably 82% or more, more preferably 83% or more, more preferably 84% or more, more preferably 85% or more, more preferably 86% or more, more preferably 87% or more, more preferably 88% or more, more preferably 89% or more, more preferably 90% or more, more preferably 91% or more, more preferably 92% or more, more preferably 93% or more, more preferably 94% or more, more preferably 95% or more, more preferably 96% or more, more preferably 97% or more, more preferably 98% or more, more preferably 99% or more, and preferably single phase (100%).

The α ratio is calculated from the following formula.

$$α ratio = ( α ( 210 ) + α ( 201 ) ) / ( α ( 210 ) + α ( 201 ) + β ( 101 ) + β ( 120 ) ) \times 100$$

In the above formula, α(201), α(210), β(101) and β(120) are respectively synonymous with α(201), α(210), β(101) and β(120) in the β ratio.

Examples of a sintering aid include a compound containing Li, Mg, Ca, Y, La or the like, and specific examples include Al₂O₃, Y₂O₃, AlN, and MgAl₂O₄.

Examples of a binder include an organic substance.

Examples of a solvent include water, an alcohol, and a hydrocarbon. It should be noted that the conventional silicon nitride sintered body uses αSi₃N₄ as the raw material, and in a case in which a solvent containing an oxygen atom such as water is used, oxygen atoms may enter the Si₃N₄, thereby affecting the properties of the final product, i.e., the silicon nitride sintered body. For this reason, in a case in which a conventional silicon nitride sintered body is produced, it is preferable to select a solvent appropriately. On the other hand, since SiAlON already contains an oxygen atom as a constituent element, even when water is used in case in which SiAlON is used as the raw material, the influence on the properties of the final product is low; and the options for the producing process are broadened.

Examples of the sintering accelerator include compounds containing Ti, Hf, Zr, W, Mo, Nb, or Cr, and oxides, carbides, nitrides, silicides, borides of these elements. The element of the sintering accelerator may, in some cases, function to enhance the dispersibility in the crystal structure and the mechanical strength of the silicon nitride-type sintered body. The sintering accelerator is preferably a compound containing Ti or Mo. The compound containing Ti or Mo also functions as a light-shielding agent that imparts black coloration and opacity to the silicon nitride-type sintered body.

In a case in which a sintering accelerator is used, from the viewpoint of exerting the effect of adding the sintering accelerator, a content of the sintering accelerator is preferably 0.1% by mass or more, preferably 0.2% by mass or more, preferably 0.3% by mass or more, preferably 0.4% by mass or more, and preferably 0.5% by mass or more, in terms of oxide equivalent, with respect to the silicon nitride-type material, in terms of oxide equivalent. From the viewpoint of further increasing the mechanical strength, the content of the sintering accelerator is preferably 5% by mass or less, preferably 3% by mass or less, preferably 2% by mass or less, and preferably 1% by mass or less, in terms of oxide equivalent, with respect to the silicon nitride-type material.

The raw material composition may be molded into a desired shape before firing for sintering. As the molding method, known molding methods such as uniaxial pressing, die pressing, doctor blade, rubber pressing, and cold isostatic pressing (CIP) can be used. The molded product may be further pressurized by CIP or the like. The molded product may also be degreased before firing.

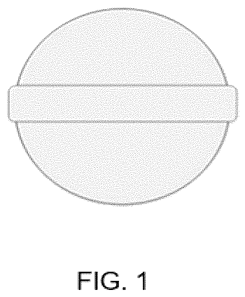

In a case in which spherical molding is performed using an upper die and a lower die as molds, it is often the case, due to the design of the molds, that a clearance is provided between the upper die and the lower die upon closing. In such a case, the molded product obtained has a protrusion derived from the clearance portion of the molds. For example, in a case in which a mold composed of a hemispherical upper die and a hemispherical lower die are used, a molded product as shown in FIG. 1 is obtained. In a case in which the protrusion is to be removed, it is preferable to remove it before firing. In a case in which the molded product is subjected to CIP treatment, it is preferable to remove the protrusion after CIP treatment and before firing. In a case in which degreasing is performed before firing, it is preferable to remove the protrusion before degreasing.

In a case in which a belt-removal process is performed before firing, a height of the belt-shaped protrusions is preferably 500 μm or less, preferably 40 μm or less, preferably 30 μm or less, preferably 20 μm or less, preferably 10 μm or less, and most preferably zero.

In addition, the product may be granulated before molding, and the granulated product may be used for molding. The granulation method is not particularly limited, and examples thereof include spray drying.

Degreasing may be performed in either a non-oxidizing atmosphere or an oxidizing atmosphere. In a case in which degreasing is performed in a non-oxidizing atmosphere, the degreasing temperature is preferably from 550 to 800° C., and in a case in which degreasing is performed in an oxidizing atmosphere such as air, the degreasing temperature is preferably from 400 to 650° C. The heating time at these temperatures is preferably from 1 to 2 hours.

The silicon nitride-type material or molded product is preferably heated under reduced pressure, preferably in a vacuum of 0.01 Pa or less. The heating temperature in a vacuum is preferably from 1200 to 1500° C., and the holding time at this heating temperature is preferably from 1 to 10 hours.

After heating under reduced pressure or vacuum, it is preferable to sinter in an inert gas atmosphere such as nitrogen gas or argon gas. Either pressureless sintering or pressure sintering may be employed, and the sintering temperature is preferably from 1600 to 1850° C. In a case in which the sintering temperature is set to 1600° C. or higher, densification of the sintered body becomes sufficient, defect rate is reduced, mechanical strength is further improved, and rolling fatigue life is enhanced when used as a bearing rolling element. In a case in which the sintering temperature is set to 1850° C. or lower, it becomes easier to obtain a sintered body having a desired composition.

As the pressure sintering method, various pressure sintering methods such as atmospheric pressure sintering, hot pressing, and hot isostatic pressing (HIP) are used.

T The α-phase undergoes α phase transformation into the β-phase due to the presence of oxygen on the surface during firing. When M-αSiAlON transforms into β-SiAlON, the metal atom M incorporated in the crystal lattice migrates from the inside of the lattice to the grain boundary interface outside the lattice, thereby causing solid solution bonding between crystal grains. Accordingly, a sintered body obtained by sintering M-αSiAlON becomes uniform and densified, as shown, for example, in FIG. 3(A).

After sintering, it is preferable to subject the obtained silicon nitride-type sintered body to hot isostatic pressing (HIP) treatment at a temperature of from 1600° C. to 1850° C. in a non-oxidizing atmosphere at a pressure of 300 atm or more. By subjecting the sintered body to hot isostatic pressing (HIP) treatment, defects that serve as initiation points for fatigue fracture can be reduced, and in a case in which the sintered body is used as a bearing rolling element, sliding properties and rolling fatigue life characteristics are further improved.

### <Silicon Nitride-Typed Blank Ball>

The silicon nitride-type blank ball in the present disclosure may be formed from the silicon nitride-type sintered body in the present disclosure. An example of the silicon nitride-type blank ball in the present disclosure includes a spherical body having a difference between the maximum and minimum diameters of 100 μm or less and a belt-like protrusion height of 50 μm or less. The second silicon nitride-type sintered body in the present disclosure has excellent machinability, and therefore even in the state of a blank ball, it is possible to obtain a spherical body having a difference between the maximum and minimum diameters of 100 μm or less and a belt-like protrusion height of 50 μm or less.

The protrusion height in the silicon nitride-type blank ball as an example in the present disclosure is 50 μm or less, preferably 40 μm or less, more preferably 30 μm or less, more preferably 20 μm or less, even more preferably 10 μm or less, and particularly preferably zero.

The silicon nitride-type blank ball as an example in the present disclosure has a difference between the maximum and minimum diameters of 100 μm or less, preferably 90 μm or less, preferably 80 μm or less, preferably 70 μm or less, preferably 60 μm or less, and preferably 50 μm or less.

### <Bearing Rolling Element>

The bearing rolling element in the present disclosure is composed of the silicon nitride-type sintered body in the present disclosure. The bearing rolling element can be obtained by subjecting the silicon nitride-type sintered body in the present disclosure to mirror finishing or the like. Any mirror finishing method may be employed as long as an arithmetic average surface roughness Ra can be reduced to 0.5 μm or less.

The arithmetic average surface roughness Ra of the bearing rolling element is preferably 0.5 μm or less, preferably 0.4 μm or less, preferably 0.3 μm or less, preferably 0.2 μm or less, preferably 0.1 μm or less, preferably 0.08 μm or less, preferably 0.06 μm or less, preferably 0.05 μm or less.

The surface layer may be cut prior to mirror finishing. Since the silicon nitride-type sintered body in the present disclosure has fewer defects such as snowflakes and pores in the surface layer compared to conventional silicon nitride-type sintered bodies, cutting of the surface layer may be omitted or an amount of the surface layer to be cut may be reduced.

### <Bearing>

A bearing in the present disclosure includes the bearing rolling element in the present disclosure. Since the bearing rolling element in the present disclosure use a silicon nitride sintered body having fewer defects or a silicon nitride-type sintered body having good machinability, it is also suitable as a bearings for electric vehicles.

### EXAMPLE

The present invention will be described below using examples, but the present invention is not limited thereto.

Examples 1 to 5 and 10 to 27 are examples, and Examples 6 to 9 and 28 are comparative examples.

The raw materials and sintering aids shown in Tables 1 to 5 were prepared. The Ca-αSiAlON and Y-αSiAlON used as raw materials were synthesized by the combustion synthesis method, and the α ratio was as shown in Tables 1 to 5. The αSi₃N₄ used as raw material in Examples 6 to 9 was Denka's product name 9FWS, synthesized by the direct nitriding method, with an average particle size (D50) of 0.7 μm and an α ratio of 91%.

A solvent was added to the raw materials and sintering aids in the composition shown in Tables 1 to 5, and the mixture was mixed for 48 hours to obtain a slurry. In Tables 1 to 5, a blank entry for component indicates that the component is not included in the composition. In Example 5, a mixture was obtained by adding an organic binder to the raw materials without adding a sintering aid or solvent. These slurries or mixtures were spray-dried to obtain granulated powders.

The obtained granulated powders were placed in a mold and press-mold under a molding pressure to form either a rectangular body of 60 mm×50 mm×10 mm in thickness or a spherical body having a diameter of 13.5 mm, and then subjected to CIP treatment.

The obtained molded product was heated to 600° C. for 1 hour in an air atmosphere to perform a degreasing treatment, and then heated from room temperature to 1400° C. for 2 hours under a vacuum of 10⁻² Pa or less, and then pressure-sintered at 1750° C. for 4 or 5 hours in a nitrogen gas atmosphere of 0.6 MPa to obtain a sintered body.

Furthermore, for Examples 2, 6, and 8 to 27, the obtained sintered bodies were subjected to hot isostatic pressing (HIP) treatment in which it was heated at from 1650° C. to 1800° C. for 1 hour in a nitrogen gas atmosphere at a pressure of 100 MPa.

In addition, for Example 3, after performing the above-described degreasing treatment, the above pressure sintering was not performed, and instead, a sintered body was obtained by firing at 1800° C. for 2 hours under a nitrogen gas atmosphere while applying a pressure of 40 MPa using a hot press.

In Example 28, a commercially available silicon nitride blank ball (manufactured by Tsubaki Nakashima Co., Ltd.) is used.

The compositions of the obtained silicon nitride-type sintered bodies were analyzed using EPMA (JXA-8500F manufactured by JEOL Ltd. and standard samples), and the results are shown in Tables 1 to 5.

The physical properties of the obtained silicon nitride-type sintered body were also evaluated using the above measurement methods. The results are shown in Tables 1 to 5.

Note that “ND” indicates that the measurement was not performed. A blank entry for the metal M content in the matrix phase or the grain boundary phase indicates that the value was below the detection limit.

The term “Raman peak intensity ratio” in Tables 1 to 5 indicates a ratio of the maximum peak intensity at 170 to 190 cm⁻¹ to the minimum peak intensity at 177 to 197 cm⁻¹ in the Raman spectrum.

The term “Raman peak position” item in Tables 1 to 5 indicates a position of the peak top at 177 to 197 cm⁻¹ in the Raman spectrum.

The term “presence or absence of sintered altered layer” in Tables 1 to 5 defined such that it is marked as “present” when snowflakes of 50 μm or more are observed within a region up to 250 μm inward from the surface of the sintered body, and as “absent” when no such snowflakes are observed.

The X-ray diffraction measurements were performed using a “Smart lab” manufactured by Rigaku Corporation, a “D/teXUltra” manufactured by Rigaku Corporation as a detector, and “PDXL2” manufactured by Rigaku Corporation as an X-ray analysis software.

Elemental analysis of silicon nitride-type sintered bodies was performed using a “JXA-8500F” manufactured by JEOL Ltd. as an electron probe microanalyzer (EPMA) and standard samples manufactured by JEOL Ltd. Elemental analysis of powders was performed using a “ZSX Primus II” manufactured by Rigaku Corporation.

Raman spectroscopy was performed using a “LabRAM HR Evolution” manufactured by Horiba Ltd.

A Calotest manufactured by Anton Paar was used to measure the polishing rate.

A “SU6600” manufactured by Hitachi High-Technologies Corporation was used as a scanning electron microscope (SEM), with acceleration voltage of 6 kV, probe current of medium, emission current of 29 μA, extraction voltage of 1.70 kV, detector conditions of reflected electrons, suppressor voltage of 300 V, WD of 15 mm, and C-coat of approximately 24 nm.

The EDS analyzer used was a Noran system 6 manufactured by Thermo Fisher Scientific, with a detector: Thermo Fisher Scientific Ultradry, map resolution: 512×384, map pixel size: 0.01 μm, magnification: 25,000×, kernel size: 5×5, minimum valid intensity: high, filter fit type: high precision, quantitative peak separation method: standardless filter method, correction method: prober (Phi-Rho-Z).

The thrust rolling test was performed using an apparatus manufactured by Fuji Test Machinery Mfg. Co., Ltd.

TABLE 1

| | | | Example 1 | Example 2 | Example 3 | Example 4 | Example 5 | Example 6 |
|---|---|---|---|---|---|---|---|---|
| Raw material | | | Ca-aSiAlON | Ca-aSiAlON | Ca-aSiAlON | Ca-aSiAlON | Y-aSiAlON | αSi₃N₄ |
| α ratio | | | 100% | 100% | 100% | 100% | 100% | 91% |
| Sintering aid | Al₂O₃ | % by mass | | | | | | 4 |
| | AlN | % by mass | | | | | | |
| | SiO₂ | % by mass | | | 2 | 3 | | |
| | Y₂O₃ | % by mass | | | 3 | | | 3.8 |
| | MgAl₂O₄ | % by mass | | | | | | |
| Additive | CaO | % by mass | | | | | | |
| Molding | | | Sphere | Sphere | Cuboid | Sphere | Cuboid | Sphere |
| Pressure sintering | | | 1750° C. 5 h | 1750° C. 5 h | None | 1750° C. 5 h | 1750° C. 5 h | 1750° C. 4 h |
| HIP | | | None | 1650° C. 1 h | None | None | None | 1650° C. 1 h |
| Hot press | | | None | None | 1800° C./ | None | None | None |
| | | | | | 40 MPa/2 h | | | |
| Composition | Si | % by mass | 50.6 | 47.5 | 45.6 | 44.3 | 39.5 | 51.1 |
| | Al | % by mass | 7.3 | 6.1 | 6.7 | 7.4 | 9.5 | 3.7 |
| | Mg | % by mass | 0.0 | 0.0 | 0.0 | 0.05 | 0.0 | 0.0 |
| | Ca | % by mass | 3.1 | 2.7 | 2.9 | 2.8 | 0.0 | 0.0 |
| | Y | % by mass | 0.0 | 0.0 | 1.7 | 0.0 | 7.0 | 3.3 |
| | Ti | % by mass | 0.0 | 0.0 | 0.0 | 0.0 | 0.0 | 0.7 |
| | O | % by mass | 6.2 | 6.6 | 4.9 | 7.5 | 7.0 | 2.8 |
| | N | % by mass | 32.8 | 37.0 | 38.0 | 38.0 | 37.0 | 38.3 |
| | Fe | % by mass | 0.0 | 0.0 | 0.0 | 0.0 | 0.0 | 0.0 |
| | W | % by mass | 0.0 | 0.0 | 0.0 | 0.0 | 0.0 | 0.0 |
| | La | % by mass | 0.0 | 0.0 | 0.0 | 0.0 | 0.0 | 0.0 |
| Total content of metal M | | % by mass | 3.1 | 2.7 | 4.6 | 2.9 | 7.0 | 3.3 |
| β ratio | | % | 38 | 85 | 71 | 35 | 10 | 100 |
| Fracture toughness | | MPa · m^{1/2} | 6.0 | 6.2 | 7.1 | 6.5 | 5.0 | 6.0 |
| Major axis of pore | | μm | 20 | <10 | 20 | 20 | 20 | <10 |
| Polishing rate (Calotest) | | μm | 4.2 | 4.2 | 4.1 | 4.2 | 4.2 | 3.0 |
| Thrust rolling test | | number of | ND | ND | ND | ND | ND | ND |
| | | rotations | | | | | | |
| Content in matrix | Mg | % by mass | | | | | | |
| phase | Ca | % by mass | 3.7 | 4.5 | 2.5 | 3.8 | 4.5 | |
| | Y | % by mass | | | 2 | | | 4.4 |
| Content in grain | Mg | % by mass | | | | | | |
| boundary phase | Ca | % by mass | 19.3 | 17.6 | 15.5 | 17.9 | | |
| | Y | % by mass | | | 10 | | 34.9 | 26.4 |
| Raman peak intensity ratio | | | 1.17 | 1.26 | 1.28 | 1.24 | 1.23 | 3.04 |
| Raman peak position | | cm⁻¹ | 193.0 | 193.0 | 193.0 | 193.9 | 196.4 | 200.7 |
| Density | | g/cm³ | 3.16 | 3.22 | 3.18 | 3.20 | 3.27 | 3.24 |
| Young's modulus | | GPa | 308 | 290 | 332 | 301 | 310 | 308 |
| Thermal expansion coefficient | | ppm | ND | 2.9 | ND | ND | ND | 3.0 |
| Vickers hardness | | GPa | 1685 | 1489 | 1440 | 1590 | 1775 | 1490 |
| | Average | MPa · m^{1/2} | 533 | 903 | 809 | ND | ND | 1000 |
| Three-point | Weibull | | ND | 12 | ND | | | ND |
| bending strength | modulus | | | | | | | |
| Maximum major | Inner | μm | <25 | <25 | <25 | <25 | <25 | <25 |
| axis of snowflake | portion | | | | | | | |
| | Outer | μm | <25 | <25 | — | <25 | — | 100 |
| | periphera | | | | | | | |
| | 1 portion | | | | | | | |
| Sintered altered layer | | presence/ | absence | absence | — | absence | — | presence |
| | | absence | | | | | | |
| Crushing strength | Average | kN | 17.9 | 22.0 | ND | 25.4 | ND | 24.3 |
| | Weibull | | ND | 15 | | ND | | 20 |
| | modulus | | | | | | | |

| | | | | | | | |
|---|---|---|---|---|---|---|---|
| Grinding rate | μm/sec | 2.8 | 3.3 | ND | ND | ND | 2.6 |
| Thermal conductivity | W/(m · K) | ND | 9 | ND | ND | ND | 25 |
| Volume resistivity | Ω · cm | ND | >10¹⁶ | ND | ND | ND | >10¹⁴ |

TABLE 2

| | | | Example 7 | Example 8 | Example 9 | Example 10 | Example 11 | Example 12 |
|---|---|---|---|---|---|---|---|---|
| Raw material | | | αSi₃N₄ | αSi3N₄ | Ca-aSiAlON | Ca-aSiAlON | Ca-aSiAlON | Ca-aSiAlON |
| α ratio | | | 91% | 91% | 100% | 100% | 100% | 100% |
| Sintering aid | Al₂O₃ | % by mass | 3.4 | | | | | |
| | AlN | % by mass | | 2 | | | | |
| | SiO₂ | % by mass | | | | 3 | | |
| | Y₂O₃ | % by mass | 3.8 | 4 | | | | |
| | MgAl₂O₄ | % by mass | | 1.5 | | | | |
| Additive | CaO | % by mass | | | | | | |
| Molding | | | Sphere | Sphere | Sphere | Sphere | Sphere | Sphere |
| Pressure sintering | | | 1750° C. 4 h | 1750° C. 4 h | 1750° C. 5 h | 1750° C. 5 h | 1750° C. 5 h | 1750° C. 5 h |
| HIP | | | None | 1650° C. 1 h | 1650° C. 1 h | 1650° C. 1 h | 1650° C. 1 h | 1650° C. 1 h |
| Hot press | | | None | None | None | None | None | None |
| Composition | Si | % by mass | 50.8 | 50.4 | 51.6 | 50.9 | 51.2 | 49.1 |
| | Al | % by mass | 3.6 | 2.6 | 7.7 | 7.4 | 7.6 | 7.4 |
| | Mg | % by mass | 0.0 | 1.4 | 0.0 | 0.0 | 0.0 | 0.0 |
| | Ca | % by mass | 0.0 | 0.0 | 3.7 | 3.9 | 3.9 | 4.0 |
| | Y | % by mass | 3.3 | 3.8 | 0.0 | 0.0 | 0.0 | 0.0 |
| | Ti | % by mass | 0.7 | 0.0 | 0.0 | 0.0 | 0.0 | 0.0 |
| | O | % by mass | 2.6 | 2.6 | 4.4 | 7.1 | 6.4 | 9.7 |
| | N | % by mass | 38.9 | 39.2 | 32.3 | 30.7 | 30.9 | 29.8 |
| | Fe | % by mass | 0.0 | 0.0 | 0.3 | 0.0 | 0.0 | 0.0 |
| | W | % by mass | 0.0 | 0.0 | 0.0 | 0.0 | 0.0 | 0.0 |
| | La | % by mass | 0.0 | 0.0 | 0.0 | 0.0 | 0.0 | 0.0 |
| Total content of metal M | | % by mass | 3.3 | 5.2 | 3.7 | 3.9 | 3.9 | 4.0 |
| β ratio | | % | 100 | 100 | 3 | 96 | 45 | 100 |
| Fracture toughness | | MPa · m^{1/2} | 5.5 | 5.6 | 4.6 | 6.8 | 5.9 | 6.8 |
| Major axis of pore | | μm | 50 | 30 | <10 | 12 | 12 | <10 |
| Polishing rate | | μm | 3.2 | 3.3 | 3.5 | 4.2 | 4.3 | 4.1 |
| (Calotest) | | | | | | | | |
| Thrust rolling test | | number of | ND | ND | ND | 5 × 10⁷ | ND | ND |
| | | rotations | | | | | | |
| Content in matrix | Mg | % by mass | | 1.5 | | | | |
| phase | Ca | % by mass | | | 4.2 | 2.7 | 2.3 | 2.6 |
| | Y | % by mass | | 4.5 | | | | |
| Content in grain | Mg | % by mass | | 8.4 | | | | |
| boundary phase | Ca | % by mass | | | 16.7 | 8.9 | 13.4 | 10.4 |
| | Y | % by mass | | 24.6 | | | | |
| Raman peak intensity ratio | | | 3.02 | 3.04 | 1.20 | 1.54 | 1.21 | 1.65 |
| Raman peak position | | cm⁻¹ | 200.8 | 200.7 | 193.9 | 195.6 | 193.0 | 196.4 |
| Density | | g/cm³ | 3.20 | 3.23 | 3.16 | 3.13 | 3.16 | 3.16 |
| Young's modulus | | GPa | 300 | 300 | 300 | 274 | 300 | 265 |
| Thermal expansion coefficient | | ppm | ND | 3.2 | ND | ND | ND | ND |
| Vickers hardness | | GPa | 1540 | 1620 | 1813 | 1408 | 1605 | 1337 |
| | Average | MPa · m^{1/2} | ND | 980 | ND | ND | ND | ND |
| Three-point | Weibull | | | ND | | | | |
| bending strength | modulus | | | | | | | |
| Maximum major | Inner | μm | 200 | 50 | <10 | <10 | <10 | <10 |
| axis of snowflake | portion | | | | | | | |
| | Outer | μm | 200 | 50 | <10 | <10 | <10 | <10 |
| | peripheral | | | | | | | |
| | portion | | | | | | | |
| Sintered altered layer | | presence/ | presence | presence | absence | absence | absence | absence |
| | | absence | | | | | | |
| Crushing strength | Average | kN | ND | 12.7 | ND | 27 | ND | ND |
| | Weibull | | | ND | | 25 | | |
| | modulus | | | | | | | |

| | | | | | | | |
|---|---|---|---|---|---|---|---|
| Grinding rate | μm/sec | ND | ND | ND | ND | ND | ND |
| Thermal conductivity | W/(m · K) | ND | 17 | ND | 10 | ND | ND |
| Volume resistivity | Ω · cm | ND | ND | ND | ND | ND | ND |

TABLE 3

| | | | Example 13 | Example 14 | Example 15 | Example 16 | Example 17 | Example 18 |
|---|---|---|---|---|---|---|---|---|
| Raw material | | | Ca-aSiAlON | Ca-SiAlON | Ca-aSiAlON | Ca-aSiAlON | Ca-aSiAlON | Ca-aSiAlON |
| α ratio | | | 100% | 100% | 100% | 100% | 100% | 100% |
| Sintering aid | Al₂O₃ | % by mass | | | | | | |
| | AlN | % by mass | | | | | | |
| | SiO₂ | % by mass | | 6 | | 3 | | |
| | Y₂O₃ | % by mass | | | | | | |
| | MgAl₂O₄ | % by mass | | | | | | |
| | CaO | % by mass | | | | | | |
| Molding | | | Sphere | Sphere | Sphere | Sphere | Sphere | Sphere + |
| | | | | | | | | Cuboid |
| Pressure sintering | | | 1750° C. 5 h | 1775° C. 2 h | 1775° C. 2 h | 1775° C. 2 h | 1775° C. 2 h | 1775° C. 2 h |
| HIP | | | 1650° C. 1 h | 1650° C. 1 h | 1700° C. 1 h | 1700° C. 1 h | 1700° C. 1 h | 1700° C. 1 h |
| Hot press | | | None | None | None | None | None | None |
| Composition | Si | % by mass | 50.9 | 52.1 | 50.2 | 51.8 | 50.2 | 49.3 |
| | Al | % by mass | 7.6 | 7.2 | 7.1 | 6.6 | 6.7 | 7.6 |
| | Mg | % by mass | 0.0 | 0.0 | 0.0 | 0.0 | 0.0 | 0.0 |
| | Ca | % by mass | 4.0 | 3.9 | 3.9 | 2.7 | 4.2 | 4.2 |
| | Y | % by mass | 0.0 | 0.0 | 0.0 | 0.0 | 0.0 | 0.0 |
| | Ti | % by mass | 0.0 | 0.0 | 0.0 | 0.0 | 0.0 | 0.0 |
| | O | % by mass | 5.6 | 7.8 | 7.6 | 5.0 | 4.0 | 7.2 |
| | N | % by mass | 31.6 | 29.1 | 31.1 | 33.9 | 34.9 | 31.7 |
| | Fe | % by mass | 0.3 | 0.0 | 0.1 | 0.0 | 0.0 | 0.0 |
| | W | % by mass | 0.0 | 0.0 | 0.0 | 0.0 | 0.0 | 0.0 |
| | La | % by mass | 0.0 | 0.0 | 0.0 | 0.0 | 0.0 | 0.0 |
| Total content of metal M | | % by mass | 4.0 | 3.9 | 3.9 | 2.7 | 4.2 | 4.2 |
| β ratio | | % | 75 | 100 | 100 | 70 | 11 | 74 |
| Fracture toughness | | MPa · m^{1/2} | 6.7 | 7.2 | 7.9 | 7.2 | 5.2 | 7.5 |
| Major axis of pore | | μm | <10 | 15 | <10 | <10 | <10 | <10 |
| Polishing rate (Calotest) | | μm | 4.2 | 4.0 | 3.9 | 3.8 | 4.1 | 4.3 |
| Thrust rolling test | | number of | ND | ND | 1 × 10⁸ | ND | ND | ND |
| | | rotations | | | | | | |
| Content in matrix | Mg | % by mass | | | | | | |
| phase | Ca | % by mass | 3.0 | 3.4 | 3.4 | 3.4 | 3.5 | 3.2 |
| | Y | % by mass | | | | | | |
| Content in grain | Mg | % by mass | | | | | | |
| boundary phase | Ca | % by mass | 15.3 | 10.1 | 11.8 | 10.9 | 15.3 | 18.7 |
| | Y | % by mass | | | | | | |
| Raman peak intensity ratio | | | 1.17 | 1.65 | 1.63 | 1.42 | 1.29 | 1.25 |
| Raman peak position | | cm⁻¹ | 193.9 | 196.4 | 195.6 | 194.7 | 193.0 | 194.7 |
| Density | | g/cm³ | 3.16 | 3.15 | 3.15 | 3.14 | 3.16 | 3.15 |
| Young's modulus | | GPa | 302 | 298 | 290 | 301 | 336 | 313 |
| Thermal expansion coefficient | | ppm | ND | ND | ND | ND | ND | ND |
| Vickers hardness | | GPa | 1489 | 1412 | 1432 | 1454 | 1758 | 1597 |
| | Average | MPa · m^{1/2} | ND | ND | ND | ND | ND | ND |
| Three-point | Weibull | | | | | | | |
| bending strength | modulus | | | | | | | |
| Maximum major | Inner | μm | <10 | 50 | <10 | <10 | <10 | <10 |
| axis of snowflake | portion | | | | | | | |
| | Outer | μm | <10 | 90 | <10 | <10 | <10 | <10 |
| | peripheral | | | | | | | |
| | portion | | | | | | | |
| Sintered altered layer | | presence/ | absence | presence | absence | absence | absence | absence |
| | | absence | | | | | | |
| Crushing strength | Average | kN | ND | ND | ND | ND | ND | ND |
| | Weibull | | | | | | | |
| | modulus | | | | | | | |

| | | | | | | | |
|---|---|---|---|---|---|---|---|
| Grinding rate | μm/sec | ND | ND | ND | ND | ND | ND |
| Thermal conductivity | W/(m · K) | ND | ND | 9 | ND | ND | ND |
| Volume resistivity | Ω · cm | ND | ND | ND | ND | ND | ND |

TABLE 4

| | | | Example 19 | Example 20 | Example 21 | Example 22 | Example 23 |
|---|---|---|---|---|---|---|---|
| Raw material | | | Ca-aSiAlON | Ca-aSiAlON | Ca-aSiAlON | Ca-aSiAlON | Ca-aSiAlON |
| α ratio | | | 80% | 100% | 100% | 100% | 100% |
| Sintering aid | Al₂O₃ | % by mass | | | | | |
| | AlN | % by mass | | | | | |
| | SiO₂ | % by mass | | | | | |
| | Y₂O₃ | % by mass | | | | | |
| | MgAl₂O₄ | % by mass | | | | | |
| Additive | CaO | % by mass | | | | | 1 |
| Molding | | | Sphere + | Sphere + | Sphere | Sphere | Cuboid |
| | | | Cuboid | Cuboid | | | |
| Pressure sintering | | | 1775° C. 2 h | 1775° C. 2 h | 1775° C. 2 h | 1775° C. 2 h | 1750° C. 5 h |
| HIP | | | 1700° C. 1 h | 1700° C. 1 h | 1750° C. 1 h | 1800° C. 1 h | 1650° C. 1 h |
| Hot press | | | None | None | None | None | None |
| Composition | Si | % by mass | 50.5 | 46.9 | 50.5 | 51.1 | 48.7 |
| | Al | % by mass | 6.6 | 8.3 | 8.1 | 8.2 | 7.7 |
| | Mg | % by mass | 0.0 | 0.0 | 0.0 | 0.0 | 0.0 |
| | Ca | % by mass | 2.3 | 4.9 | 4.3 | 4.3 | 5.0 |
| | Y | % by mass | 0.0 | 0.0 | 0.0 | 0.0 | 0.0 |
| | Ti | % by mass | 0.0 | 0.0 | 0.0 | 0.0 | 0.0 |
| | O | % by mass | 5.5 | 7.7 | 7.3 | 7.2 | 5.7 |
| | N | % by mass | 35.1 | 32.1 | 29.8 | 29.0 | 32.9 |
| | Fe | % by mass | 0.0 | 0.1 | 0.0 | 0.2 | 0.0 |
| | W | % by mass | 0.0 | 0.0 | 0.0 | 0.0 | 0.0 |
| | La | % by mass | 0.0 | 0.0 | 0.0 | 0.0 | 0.0 |
| Total content of metal M | | % by mass | 2.3 | 4.9 | 4.3 | 4.3 | 5.0 |
| β ratio | | % | 100 | 80 | 81 | 82 | 7 |
| Fracture toughness | | MPa · m^{1/2} | 5.7 | 7.7 | 8.2 | 8.5 | 5.0 |
| Major axis of pore | | μm | <10 | <10 | <10 | <10 | <10 |
| Polishing rate (Calotest) | | μm | 3.9 | 4.3 | 4.0 | 4.2 | 4.2 |
| Thrust rolling test | | number of | ND | ND | ND | ND | ND |
| | | rotations | | | | | |
| Content in matrix | Mg | % by mass | | | | | |
| phase | Ca | % by mass | 3.2 | 3.7 | 3.6 | 3.8 | 4.3 |
| | Y | % by mass | | | | | |
| Content in grain | Mg | % by mass | | | | | |
| boundary phase | Ca | % by mass | 16.8 | 17.2 | 18 | 17.5 | 12.2 |
| | Y | % by mass | | | | | |
| Raman peak intensity ratio | | | 1.48 | 1.26 | 1.28 | 1.25 | 1.17 |
| Raman peak position | | cm⁻¹ | 193.9 | 191.3 | 191.3 | 191.3 | 193.9 |
| Density | | g/cm³ | 3.15 | 3.14 | 3.15 | 3.16 | 3.16 |
| Young's modulus | | GPa | 306 | 303 | 305 | 302 | 322 |
| Thermal expansion coefficient | | ppm | ND | ND | ND | ND | ND |
| Vickers hardness | | GPa | 1466 | 1451 | 1423 | 1468 | 1702 |
| | Average | MPa · m^{1/2} | ND | ND | ND | ND | ND |
| Three-point | Weibull | | | | | | |
| bending strength | modulus | | | | | | |
| Maximum major | Inner | μm | <10 | <10 | <10 | <10 | <10 |
| axis of snowflake | portion | | | | | | |
| | Outer | μm | <10 | <10 | <10 | <10 | <10 |
| | peripheral | | | | | | |
| | portion | | | | | | |
| Sintered altered layer | | presence/ | absence | absence | absence | absence | absence |
| | | absence | | | | | |
| Crushing strength | Average | kN | ND | ND | ND | ND | ND |
| | Weibull | | | | | | |
| | modulus | | | | | | |

| | | | | | | |
|---|---|---|---|---|---|---|
| Grinding rate | μm/sec | ND | ND | ND | ND | ND |
| Thermal conductivity | W/(m · K) | ND | 10 | 10 | 10 | 11 |
| Volume resistivity | Ω · cm | ND | >10¹⁴ | >10¹⁴ | >10¹⁴ | ND |

TABLE 5

| | | | Example 24 | Example 25 | Example 26 | Example 27 | Example 28 |
|---|---|---|---|---|---|---|---|
| Raw material | | | Ca-aSiAlON | Y-aSiAlON | Y-aSiAlON | Ca-aSiAlON | |
| α ratio | | | 100% | 100% | 100% | 100% | |
| Sintering aid | Al₂O₃ | % by mass | | | | | |
| | AlN | % by mass | | | | | |
| | SiO₂ | % by mass | | | | | |
| | Y₂O₃ | % by mass | | | | | |
| | MgAl₂O₄ | % by mass | | | | | |
| Additive | CaO | % by mass | 3 | | | | |
| Molding | | | Cuboid | Cuboid | Cuboid | Sphere + | Sphere |
| | | | | | | Cuboid | |
| Pressure sintering | | | 1750° C. 5 h | 1750° C. 5 h | 1750° C. 5 h | 1775° C. 2 h | |
| HIP | | | 1650° C. 1 h | 1650° C. 1 h | 1650° C. 1 h | 1700° C. 1 h | |
| Hot press | | | None | None | None | None | |
| Composition | Si | % by mass | 48.8 | 47.5 | 47.5 | 46.5 | 54.8 |
| | Al | % by mass | 7.6 | 10.0 | 10.1 | 7.7 | 3.6 |
| | Mg | % by mass | 0.0 | 0.0 | 0.0 | 0.0 | 0.0 |
| | Ca | % by mass | 6.5 | 0.0 | 0.0 | 4.9 | 0.0 |
| | Y | % by mass | 0.0 | 6.5 | 6.4 | 0.0 | 3.7 |
| | Ti | % by mass | 0.0 | 0.0 | 0.0 | 1.0 | 0.7 |
| | O | % by mass | 5.8 | 4.2 | 5.4 | 7.7 | 4.0 |
| | N | % by mass | 31.1 | 31.8 | 30.5 | 32.1 | 33.1 |
| | Fe | % by mass | 0.1 | 0.0 | 0.2 | 0.1 | 0.2 |
| | W | % by mass | 0.0 | 0.0 | 0.0 | 0.0 | 0.0 |
| | La | % by mass | 0.0 | 0.0 | 0.0 | 0.0 | 0.0 |
| Total content of metal M | | % by mass | 6.5 | 6.5 | 6.4 | 4.9 | 3.7 |
| β ratio | | % | 55 | 11 | 60 | 75 | 100 |
| Fracture toughness | | MPa · m^{1/2} | 5.5 | 5.9 | 6.5 | 7.6 | 6.1 |
| Major axis of pore | | μm | <10 | <10 | <10 | <10 | <10 |
| Polishing rate (Calotest) | | μm | 4.4 | 4.4 | 4.4 | 4.1 | 2.9 |
| Thrust rolling test | | number of | ND | ND | ND | ND | 1×10⁸ |
| | | rotations | | | | | |
| Content in matrix | Mg | % by mass | | | | | |
| phase | Ca | % by mass | 3.9 | 5.8 | 7.1 | 3.5 | |
| | Y | % by mass | | | | | 4.4 |
| Content in grain | Mg | % by mass | | | | | |
| boundary phase | Ca | % by mass | 13.9 | | | 16.5 | |
| | Y | % by mass | | 35.3 | 38.6 | | 26.4 |
| Raman peak intensity ratio | | | 1.21 | 1.16 | 1.23 | 1.42 | 3.06 |
| Raman peak position | | cm⁻¹ | 193.0 | 192.2 | 188.7 | 194.7 | 200.7 |
| Density | | g/cm³ | 3.14 | 3.27 | 3.27 | 3.15 | 3.23 |
| Young's modulus | | GPa | 314 | 343 | 323 | 305 | 304 |
| Thermal expansion coefficient | | ppm | ND | ND | ND | ND | ND |
| Vickers hardness | | GPa | 1602 | 1854 | 1624 | 1432 | 1501 |
| | Average | MPa · m^{1/2} | ND | ND | ND | ND | ND |
| Three-point | Weibull | | | | | | |
| bending strength | modulus | | | | | | |
| Maximum major | Inner | μm | <10 | <10 | <10 | <10 | 12 μm |
| axis of snowflake | portion | | | | | | |
| | Outer | μm | <10 | <10 | <10 | <10 | <10 |
| | peripheral | | | | | | |
| | portion | | | | | | |
| Sintered altered layer | | presence/ | absence | absence | absence | absence | — |
| | | absence | | | | | |
| Crushing strength | Average | kN | ND | ND | ND | ND | ND |
| | Weibull | | | | | | |
| | modulus | | | | | | |

| | | | | | | |
|---|---|---|---|---|---|---|
| Grinding rate | μm/sec | ND | ND | ND | ND | ND |
| Thermal conductivity | W/(m · K) | 12 | 9 | 9 | 10 | 25 |
| Volume resistivity | Ω · cm | ND | ND | ND | >10¹⁴ | ND |

FIGS. 2(A) and (B) show optical microscope photographs of cross sections of the silicon nitride-type sintered bodies of Examples 2 and 6, observed in a dark field at 10× magnification. Example 2 is shown in FIG. 2(A), and Example 6 in FIG. 2(B). The silicon nitride-type sintered body of Example 2 was homogeneous, whereas the silicon nitride-type sintered body of Example 6 exhibited defects such as snowflakes in the outer peripheral region.

FIGS. 3(A) and (B) show photographs of cross sections of the silicon nitride-type sintered bodies of Examples 2 and 6, which were mirror-finished and observed using a scanning electron microscope at 25,000 times magnification. Example 2 is shown in FIG. 3(A), and Example 6 in FIG. 3(B).

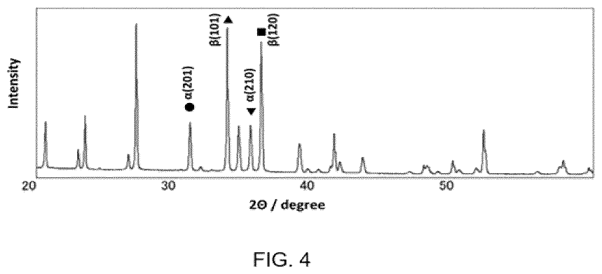

FIG. 4 shows the XRD spectrum of the silicon nitride-type sintered body obtained in Example 2.

The peak marked with “•” (2θ=from 30.5 to 32°) represents the α(201) peak, the peak marked with “▴” (2θ=from 33 to) 34° represents the β (101) peak, the peak marked with “▾” (2θ=from 35 to) 36° represents the α(210) peak, and the peak marked with “▪” (2θ=from 36 to) 37° represents the β (120) peak.

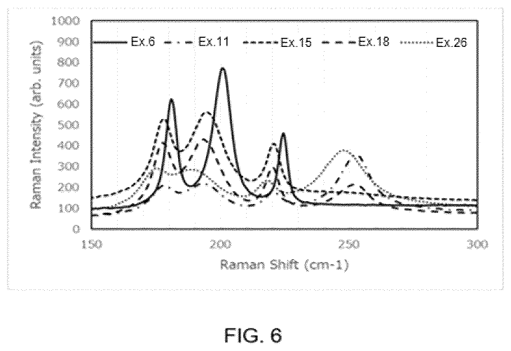

Raman spectroscopy spectra are shown in FIGS. 5(A) and (B) and FIG. 6. FIG. 5(A) is the Raman spectroscopy spectrum of the silicon nitride-type sintered body obtained in Example 2, and FIG. 5(B) is the Raman spectroscopy spectrum of the silicon nitride-type sintered body obtained in Example 6. FIG. 6 shows the Raman spectroscopy spectra of the silicon nitride-type sintered bodies obtained in Examples 6, 11, 15, 18, and 26.

The results in Tables 1 to 5 show that the silicon nitride-type sintered bodies of Examples 1 to 5 and 10 to 27, in which the total content of at least one metal M selected from the group consisting of Mg, Ca and Y is from 0.2 to 8.0% by mass, the Al content is from 4.0 to 12.0% by mass, the O content is from 4.0 to 12.0% by mass, and the fracture toughness value is from 5.0 to 10.0 MPa·m^{1/2}, have a higher polishing rate by Calotest and are more excellent in machinability than Examples 6 to 9 and 28.

A thrust rolling test was carried out on the silicon nitride-type sintered bodies of Examples 10, 15, and 28. For comparison, a same test was also carried out on high-carbon chromium steel (SUJ2), which is used as a rolling element in bearings, as a reference sample.

The SUJ2 ball caused the test machine to stop at 69 million revolutions due to increased vibration, and the test was terminated because flaking (peeling) was observed on both the rolling element and the test piece.

In the silicon nitride-type sintered body of Example 10, vibration increased at 45 million rotations, and the test was terminated. When the silicon nitride-type sintered bodies were observed after the test, flaking was found in one of the 6 samples, while no significant wear was found in the remaining 5. In the silicon nitride-type sintered body of Example 10, pores of up to 12 μm were found in the cross-section observation with an optical microscope using the above method, and it is presumed that flaking originated from the pores.

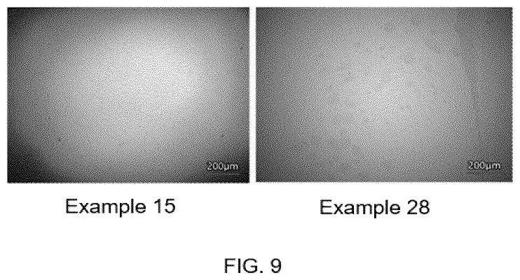

In the silicon nitride-type sintered bodies of Examples 15 and 28, no increase in vibration was observed up to 100 million rotations. When the appearance of the silicon nitride-type sintered bodies was observed after the test, no significant wear was observed by visual inspection in both Examples 15 and 28. The results of observing the surfaces of the silicon nitride-type sintered bodies of Examples 15 and 28 after the thrust rolling test using a laser microscope are shown in FIG. 9. In Example 28, observation using a laser microscope revealed the presence of an aggregate of fine flaked regions having a diameter of approximately 80 μm and a depth of approximately 0.5 μm. In contrast, in Example 15, no wear was observed by laser microscope observation, and high wear resistance was confirmed as a rolling element for bearing balls. It was found that the silicon nitride-type sintered body of Example 15 has excellent wear resistance and also exhibits superior machinability.

### INDUSTRIAL APPLICABILITY

The silicon nitride-type sintered body in the present disclosure is useful as a wear-resistant member, and can be particularly suitably used as a bearing rolling element and a bearing member.

The disclosure of Japanese Patent Application No. 2023-014185 is incorporated herein by reference in its entirety.

All documents, patent applications, and technical standards described herein are incorporated herein by reference to the same extent as if each individual document, patent application, and technical standard was specifically and individually indicated to be incorporated by reference.

1. A silicon nitride-type sintered body having a total content of at least one metal M selected from the group consisting of Mg, Ca and Y of from 0.2 to 8.0% by mass, an Al content of from 4.0 to 12.0% by mass, an O content of from 4.0 to 12.0% by mass, and a fracture toughness value of from 5.0 to 10.0 MPa·m^{1/2}.

2. The silicon nitride-type sintered body according to claim 1, comprising a matrix phase and a grain boundary phase, and a total content of the metal M in the grain boundary phase being from 2.0 to 40.0% by mass.

3. The silicon nitride-type sintered body according to claim 2, wherein a total content of the metal M in the matrix phase is from 2.0 to 10% by mass.

4. The silicon nitride-type sintered body according to claim 1, wherein the metal M is Ca.

5. The silicon nitride-type sintered body according to claim 1, comprising SiAlON in solid solution form.

6. The silicon nitride sintered-type body according to claim 1, wherein a ratio of a maximum peak intensity at from 170 to 190 cm⁻¹ to a minimum peak intensity at from 177 to 197 cm⁻¹ in a Raman spectrum is from 1.0 to 3.0.

7. The silicon nitride-type sintered body according to claim 1, wherein a peak at 185 to 210 cm⁻¹, which is attributed to a β phase, is present between from 187 to 199 cm⁻¹ in a Raman spectrum.

8. The silicon nitride-type sintered body according to claim 1, having a thermal conductivity of from 5 to 15 W/(m·K).

9. The silicon nitride-type sintered body according to claim 1, having a density of from 3.10 to 3.20 g/cm³.

10. The silicon nitride-type sintered body according to claim 1, wherein a proportion of a β phase is from 5 to 100%, and the proportion of β phase is expressed as (β(101)+β(120))/(α(210)+α(201)+β(101)+β(120))×100, and calculated from heights of peaks corresponding to an α phase (210), an α phase (201), an β phase (101), and an β phase (120) in an X-ray diffraction spectrum.

11. The silicon nitride-type sintered body according to claim 1, wherein no pores with a major axis of 10 μm or more are observed when a region, having a unit area of 5 mm×5 mm, of a cross section of the silicon nitride-type sintered body is observed under a bright field magnified from 10 to 200 times with an optical microscope.

12. The silicon nitride-type sintered body according to claim 1, wherein no snowflakes with a major axis of 25 μm or more are observed when a region of a unit area of 5 mm×5 mm of a cross section of the silicon nitride-type sintered body is observed under a dark field magnified from 10 to 200 times with an optical microscope.

13. The silicon nitride-type sintered body according to claim 1, in which no snowflakes with a major axis of 50 μm or more are observed when a region of a cross section of the silicon nitride-type sintered body within 250 μm inward from a surface of the sintered body is observed under a dark field magnified from 10 to 200 times with an optical microscope.

14. The silicon nitride-type sintered body according to claim 1, which is used for a wear-resistant member.

15. A silicon nitride-type blank ball comprising the silicon nitride-type sintered body according to claim 1, wherein a difference between a maximum diameter and a minimum diameter is 100 μm or less, and a height of a band-shaped protrusion is 50 μm or less.

16. A bearing rolling element, comprising the mirror-finished silicon nitride-type sintered body according to claim 1.

17. A bearing comprising the bearing rolling element according to claim 16.

18. The bearing according to claim 17, which is for use in an electric vehicle.
